(19) United States
(12) Patent Application Publication
(10) Pub. No.: US 2014/0245328 A1
(43) Pub. Date: Aug. 28, 2014

(54) INFORMATION PROCESSING SYSTEM, INFORMATION PROCESSING METHOD, INFORMATION PROCESSING DEVICE AND ITS CONTROL METHOD AND CONTROL PROGRAM

(71) Applicant: NEC CORPORATION, Minato-ku, Tokyo (JP)

(72) Inventors: Mitsunori Morisaki, Tokyo (JP); Hiroshi Terasaki, Tokyo (JP); Tsuyoshi Oikawa, Tokyo (JP)

(73) Assignee: NEC CORPORATION, Minato-ku, Tokyo (JP)

(21) Appl. No.: 14/347,002

(22) PCT Filed: Sep. 18, 2012
(86) PCT No.: PCT/JP2012/005928

§ 371 Date: Mar. 25, 2014

(30) Foreign Application Priority Data
Sep. 26, 2011 (JP) 2011-208743

(51) Int. Cl. G06F 9/54

(52) U.S. Cl. CPC G06F 9/541
USPC 719/319

(57) ABSTRACT

The information processing device, in which a plurality of applications are executable on different platforms respectively, includes a first operation processing means for processing, on a first platform, an operation instruction with respect to an application for the first platform operable on the first platform; a second operation processing means for processing, on a second platform different from the first platform, an operation instruction with respect to an application for the second platform operable on the second platform; and an operation control means, operable on a given platform, for activating the first operation processing means or the second operation processing means and establishing communications, based on whether an activated application is for the first platform or the second platform. The first operation processing means or the second operation processing means processes an operation instruction with respect to the application on the platform on which the activated application is operable.

### TECHNICAL FIELD

The present invention relates to a technology for executing applications on different platforms.

### BACKGROUND ART

Technologies of executing a plurality of applications on different platforms have been known. For example, Patent Document 1 discloses a technology of activating a 32-bit operating system (OS) application via an emulator in a client computer which operates in a 64-bit OS environment.
Patent Document 1: JP 2010-257033 A

### SUMMARY

However, the art described in Patent Document 1 only discloses allowing a 32-bit OS application to operate as a 64-bit OS application with use of an emulator, and fails to describe performing processing by switching between one application (e.g., 32-bit OS application) and another application (e.g., 64-bit OS application).

For example, in the case of activating a 64-bit OS application after activating a 32-bit OS application in an environment in which a 32-bit OS operates on a 64-bit computer, it is necessary to terminate a control module for activating one application and operate a control module for activating the other application. As such, it may take time to perform processing by switching a plurality of applications which operate on different platforms.

In view of the above, an exemplary object of the present invention is to provide a technology capable of solving a problem that it takes time to perform processing by switching a plurality of applications which operate on different platforms.

In order to achieve the object described above, an information processing device according to the present invention is an information processing device in which a plurality of applications are executable on different platforms, respectively. The device includes

a first operation processing means for processing, on a first platform, an operation instruction with respect to an application for the first platform operable on the first platform;

a second operation processing means for processing, on a second platform different from the first platform, an operation instruction with respect to an application for the second platform operable on the second platform; and

an operation control means, operable on a given platform, for activating the first operation processing means or the second operation processing means and establishing communications, based on whether an activated application is for the first platform or the second platform. The first operation processing means or the second operation processing means processes an operation instruction with respect to the application on a platform on which the activated application is operable.

In order to achieve the object described above, an information processing device controlling method according to the present invention is a method of controlling an information processing device in which a plurality of applications are executable on different platforms, respectively.

The information processing device includes

a first operation processing means for processing, on a first platform, an operation instruction with respect to an application for the first platform operable on the first platform;

a second operation processing means for processing, on a second platform different from the first platform, an operation instruction with respect to an application for the second platform operable on the second platform; and

an operation control means operable on a given platform.

The method includes, by the operation control means,

when the application for the first platform is driven, driving the first operation processing means and establishing communications, and

when the application for the second platform is driven, driving the second operation processing means and establishing communications.

In order to achieve the object described above, a program according to the present invention is a program for implementing

a first operation processing means for processing, on a first platform, an operation instruction with respect to an application for the first platform operable on the first platform;

a second operation processing means for processing, on a second platform different from the first platform, an operation instruction with respect to an application for the second platform operable on the second platform; and

an operation control means, operable on a given platform, for activating the first operation processing means or the second operation processing means and establishing communications, based on whether an activated application is for the first platform or the second platform, the first operation processing means or the second operation processing means processing an operation instruction with respect to the application on a platform on which the activated application is operable.

In order to achieve the object described above, a system, according to the present invention, includes

a first information processing device based on a first platform, in which an application is operable on a second platform which is different from the first platform; and

a second information processing device based on the second platform.

The first information processing device includes:
a first operation processing means for processing, on the first platform, an operation instruction with respect to an application for the first platform operable on the first platform;
a second operation processing means for processing, on the second platform, an operation instruction with respect to an application for the second platform operable on the second platform; and
an operation control means, operable on a given platform, for activating the first operation processing means or the second operation processing means and establishing communications, based on whether an activated application is for the first platform or the second platform, the first operation processing means or the second operation processing means processing an operation instruction with respect to the application on a platform on which the activated application is operable.

The first operation processing means and the second operation processing means include an information transmission and reception means for transmitting and receiving information with an operation processing means of the second information processing device.

In order to achieve the object described above, an information processing method of an information processing system is an information processing method of an information processing system in which a plurality of information processing devices, operable on different platforms, are connected over a network.

The information processing system includes:

a first information processing device based on a first platform, in which an application is operable even on a second platform which is different from the first platform; and

a second information processing device based on the second platform.

The first information processing device includes:
a first operation processing means for processing, on the first platform, an operation instruction with respect to an application for the first platform, the first operation processing means including a first information transmission and reception means for transmitting and receiving information with a third operation processing means of the second information processing device;
a second operation processing means for processing, on the second platform, an operation instruction with respect to an application for the second platform, the second operation processing means including a second information transmission and reception means for transmitting and receiving information with the third operation processing means of the second information processing device; and
an operation control means operable on a given platform.

The second information processing device includes:
the application for the second platform operable on the second platform; and
the third operation processing means for processing, on the second platform, the operation instruction with respect to the application for the second platform, the third operation processing means including a third information transmission and reception means for transmitting and receiving information with the first operation processing means and the second operation processing means of the first information processing device.

The method includes

when the application for the first platform is driven, by the operation control means, driving the first operation processing means and establishing communications;

when the application for the second platform is driven, by the operation control means, driving the second operation processing means and establishing communications; and

performing transmission and reception of information between the first operation processing means or the second operation processing means, driven by the operation control means, and the third operation processing means, via the first information transmission and reception means or the second information transmission and reception means and the third information transmission and reception means.

According to the present invention, in an environment in which a plurality of platforms exist on one computer, it is possible to perform operation processing promptly when applications are activated on the respective platforms.

### BRIEF DESCRIPTION OF DRAWINGS

FIG. 1 is a block diagram showing a configuration of an information processing device according to a first exemplary embodiment of the present invention.

FIG. 2 is a block diagram showing a configuration of an information processing device according to a second exemplary embodiment of the present invention.

FIG. 3 is a block diagram showing a first operation control section according to the second exemplary embodiment of the present invention.

FIG. 4A is a diagram showing a configuration of an operation processing section selection table according to the second exemplary embodiment of the present invention.

FIG. 4B is a diagram showing a configuration of an information generation application execution table according to the second exemplary embodiment of the present invention.

FIG. 5A is a block diagram showing a configuration of an operation processing section according to the second exemplary embodiment of the present invention.

FIG. 5B is a diagram illustrating processing performed by the respective function constituting sections of the operation processing section according to the second exemplary embodiment of the present invention.

FIG. 6 is a sequence chart showing a procedure of generating an information generation application correspondence table by the first operation control section according to the second exemplary embodiment of the present invention.

FIG. 7 is a sequence chart showing an operating procedure to start use of an information generation application for a first platform by the first operation control section according to the second exemplary embodiment of the present invention.

FIG. 8 is a sequence chart showing an operating procedure of a change from the information generation application for the first platform to an information generation application for a second platform by the first operation control section according to the second exemplary embodiment of the present invention.

FIG. 9 is a block diagram showing a hardware configuration of the information processing device according to the second exemplary embodiment of the present invention.

FIG. 10A is a flowchart showing a processing procedure performed by the information processing device according to the second exemplary embodiment of the present invention.

FIG. 10B is a flowchart showing a processing procedure of calling an operation processing module according to the second exemplary embodiment of the present invention.

FIG. 10C is a flowchart showing a processing procedure of operating an information generation application according to the second exemplary embodiment of the present invention.

FIG. 11 is a block diagram showing a configuration of an information processing device according to a third exemplary embodiment of the present invention.

FIG. 12 is a block diagram showing a configuration of an information processing device according to a fourth exemplary embodiment of the present invention.

FIG. 13 is a diagram showing a configuration of an operation processing module selection table according to the fourth exemplary embodiment of the present invention.

FIG. 14 is a block diagram showing a hardware configuration of the information processing device according to the fourth exemplary embodiment of the present invention.

FIG. 15 is a flowchart showing a processing procedure performed by the information processing device according to the fourth exemplary embodiment of the present invention.

FIG. 16 is a block diagram showing a configuration of an information processing device according to a fifth exemplary embodiment of the present invention.

FIG. 17 is a flowchart showing a processing procedure performed by the information processing device according to the fifth exemplary embodiment of the present invention.

FIG. 18 is a block diagram showing a configuration of a remote consultation system which is an information processing system according to a sixth exemplary embodiment of the present invention.

FIG. 19 is a block diagram showing configurations of an operator terminal and a client terminal in the remote consultation system according to the sixth exemplary embodiment of the present invention.

FIG. 20 is a diagram showing exemplary display screens of the operator terminal according to the sixth exemplary embodiment of the present invention.

FIG. 21 is a diagram showing an exemplary display screen of the operator terminal when an application is activated, according to the sixth exemplary embodiment of the present invention.

FIG. 22 is a diagram showing exemplary screen sharing when an application is activated on the operator terminal and the client terminal according to the sixth exemplary embodiment of the present invention.

FIG. 23 is a diagram showing an exemplary display screen when drawing, on the operator terminal according to the sixth exemplary embodiment of the present invention.

FIG. 24 is a diagram showing exemplary screen sharing when drawing, on the operator terminal and the client terminal according to the sixth exemplary embodiment of the present invention.

FIG. 25 is a diagram showing examples of platforms, applications, and an operation control module according to an exemplary embodiment of the present invention.

### EXEMPLARY EMBODIMENTS

Hereinafter, exemplary embodiments of the present invention will be described in detail with reference to the drawings. However, the constituent elements described in the following embodiments are examples, and the technical scope of the present invention is not limited to those described in the embodiments.

### First Exemplary Embodiment

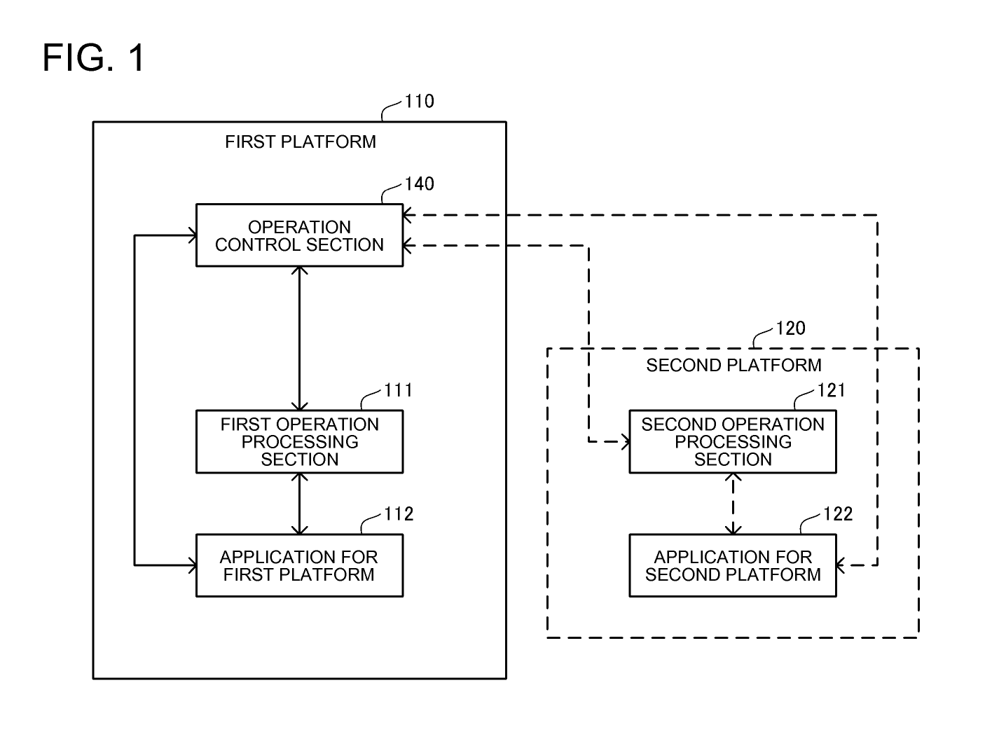

An information processing device 100 as a first exemplary embodiment of the present invention will be described using FIG. 1. The information processing device 100 is a device in which a plurality of applications are operable on different platforms, respectively.

As shown in FIG. 1, the information processing device 100 includes a first operation processing section 111, a second operation processing section 121, and an operation control section 140. The first operation processing section 111 processes, on a first platform 110, an operation instruction with respect to a first application 112 (application) for the first platform operable on the first platform 110. The second operation processing section 121 processes, on a second platform 120 which is different from the first platform, an operation instruction with respect to a first application 122 for the second platform operable on the second platform 120. The operation control section 140 (operation control means) operates on a given platform (for example, on the first platform 110). Based on whether the activated application is for the first platform 110 or the second platform 120, the operation control section 140 activates the first operation processing section 111 or the second operation processing section 121 which processes the operation instruction with respect to the first application activated on the platform on which the activated application is operable to thereby establish communications.

According to the present embodiment, in an environment in which a plurality of platforms exist on one computer, it is possible to perform operation processing promptly when applications are activated on the respective platforms.

### Second Exemplary Embodiment

Next, an information processing device according to a second exemplary embodiment of the present invention will be described. In the present embodiment, the information processing device operates in an environment in which an application for a second platform is executes on a first platform via an emulator. Here, when an information generation application compatible with a different platform is operated, an operation processing section which processes the operation by a user is switched corresponding to the information generation application. According to the present embodiment, generation of information and operation can be performed promptly even if the information generation application is switched during generation of the information.

### <Configuration of Information Processing Device>

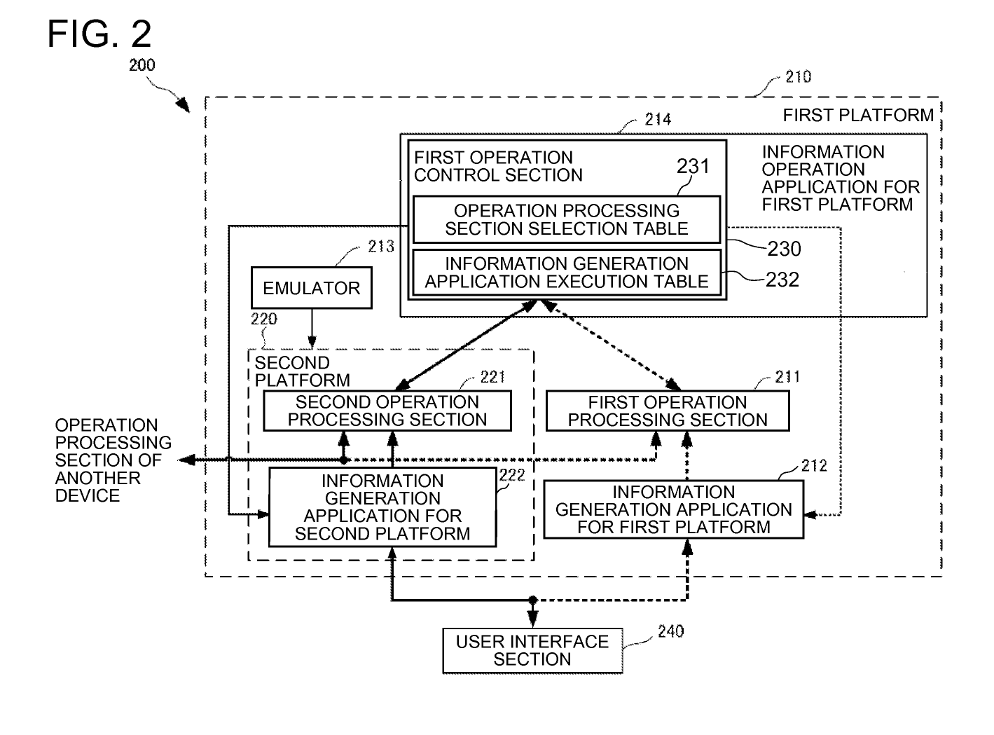

FIG. 2 is a block diagram showing a configuration of an information processing device 200 according to the present embodiment.

The information processing device 200 is able to implement a second platform 220 on a first platform 210 working as the base, via an emulator 213. A user interface section 240 includes a display screen, a touch panel, a keyboard, a pointing device, a camera, and the like which work as interfaces with a user.

On the first platform 210, a first operation processing section 211 and an information generation application 212 for the first platform are operable. The first operation processing section 211 (first operation processing means) performs operations including transmission and reception of information generated by the information generation application 212 (first application) for the first platform, in accordance with interfaces with a user using the user interface section 240. The first information generation application 212 for the first platform is a tool for generating certain information such as documents and images (including videos) based on operation instructions from the user using (via) the user interface section 240. It should be noted that in the example of FIG. 2, operations on the first platform 210 are shown by dashed arrows.

Further, on the first platform 210, the emulator 213 and an information operation application for the first platform are operable. The emulator 213 (emulation means) constructs an environment which allows the second platform 220 and the function parts operating thereon to operate on the first platform 210. This means that the emulator 213 emulates as if a program, which operates on one platform, was operating on another platform. The information operation applications for the first platform includes applications capable of activating various types of applications which operate on the first platform 210 and the second platform 220, such as a web browser (Internet Explorer (registered trademark)) for example.

On the other hand, on the second platform 220, a second operation processing section 221 and an information generation application 222 for the second platform operate. The second operation processing section 221 (second operation processing means) performs operations including transmission and reception of information generated by the information generation application 222 (application) for the second platform, in accordance with interfaces with a user using the user interface section 240. The information generation application 222 for the second platform is a tool for generating certain information including documents and images (including videos) based on operation instructions from a user using the user interface section 240. An operation between the second operation processing section 221 and the information generation application 222 for the second platform is performed on the first platform via the emulator 213. It should be noted that in the example of FIG. 2, operations on the second platform 220 are shown by solid arrows.

On the first platform 210, a first operation control section 230 prepared in the present embodiment is operable. The first operation control section 230 (operation control means) may operate regularly, or may be activated in the information operation application for the first platform. The first operation control section 230 stores an operation processing section selection table 231 and an information generation application execution table 232 therein. The operation processing section selection table 231 (storing means) is a table for storing operation processing sections in association with information generation applications in order to select an operation processing section to be activated corresponding to an information generation application to be activated. The information generation application execution table 232 stores execution flags showing whether the respective information generation applications are in execution or not.

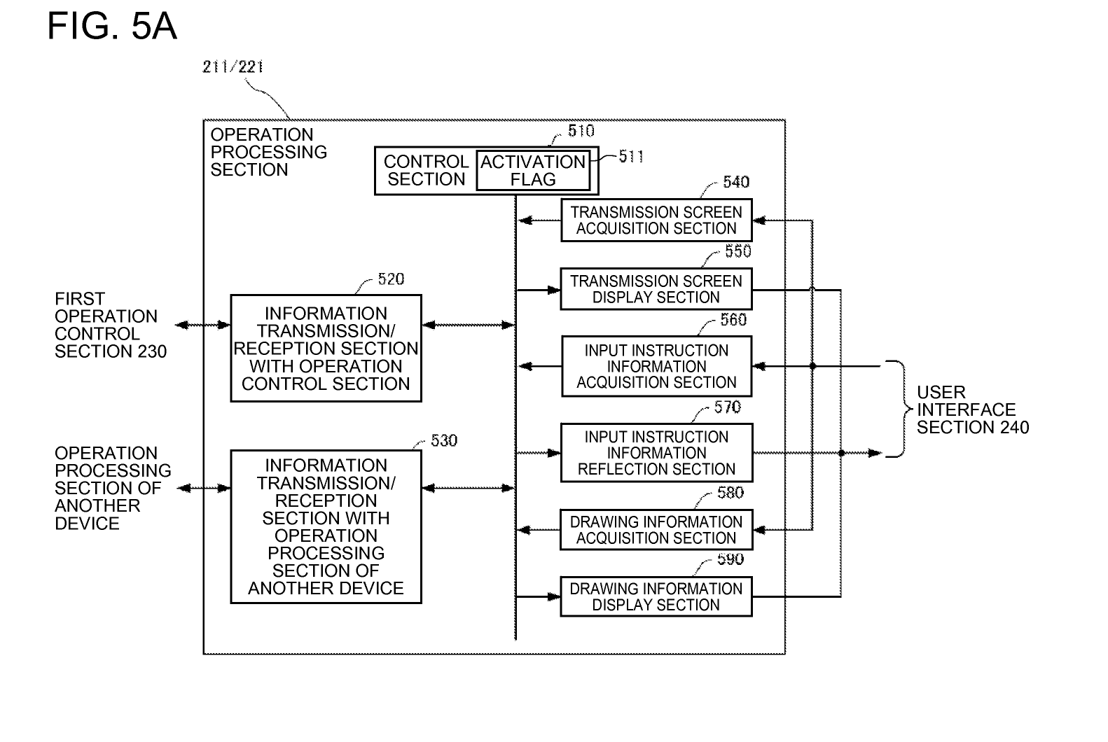

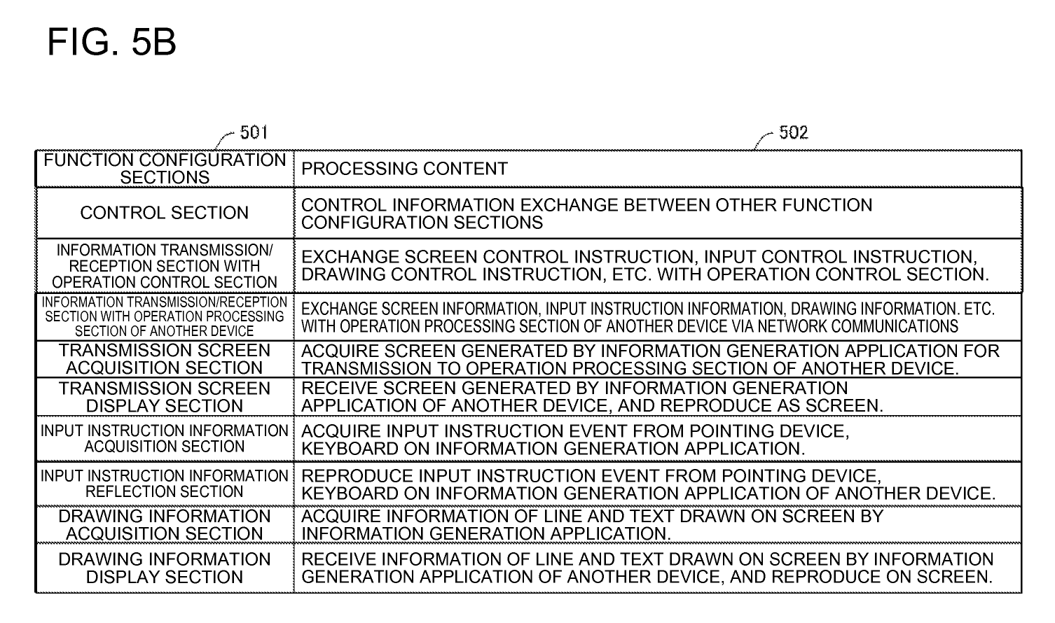

It is desirable that selection and activation of the first operation processing section 211 or the second operation processing section 221 and control after the activation by the first operation control section 230 are performed by process communications including socket communications which do not depend on a change of a platform. Further, operation processing by the first operation processing section 211 and the second operation processing section 221 includes control of a pointing device, a keyboard, images, drawing, communications, size changes, and the like (see FIG. 5B). Further, the information generation application 212 for the first platform and the information generation application 222 for the second platform include an application having a function of associating input/output of the user interface section 240 via the operation processing section and a display screen of the information processing device. It should be noted that an operation processing section (e.g., the second operation processing section 221) which operates on a platform (e.g., the second operation processing section 221) other than the first platform 210 is generated beforehand by the emulator 213.

When an information generation application to be executed by a user is selected according to the above-described configuration, the first operation control section 230 determines an operation processing section which should be activated with reference to the operation processing section selection table 231. Then, the activated operation processing section performs operation processing with respect to the information generated by the information generation application. As such, even if the user operates either the information generation application 212 for the first platform or the information generation application 222 for the second platform, it is possible to execute operation of the generated information without being aware of the platforms. For example, when the information generation processing is succeeded between the information generation application 212 for the first platform and the information generation application 222 for the second platform, the user is able to continue seamless processing without being aware of the platforms.

### (Configuration of First Operation Control Section)

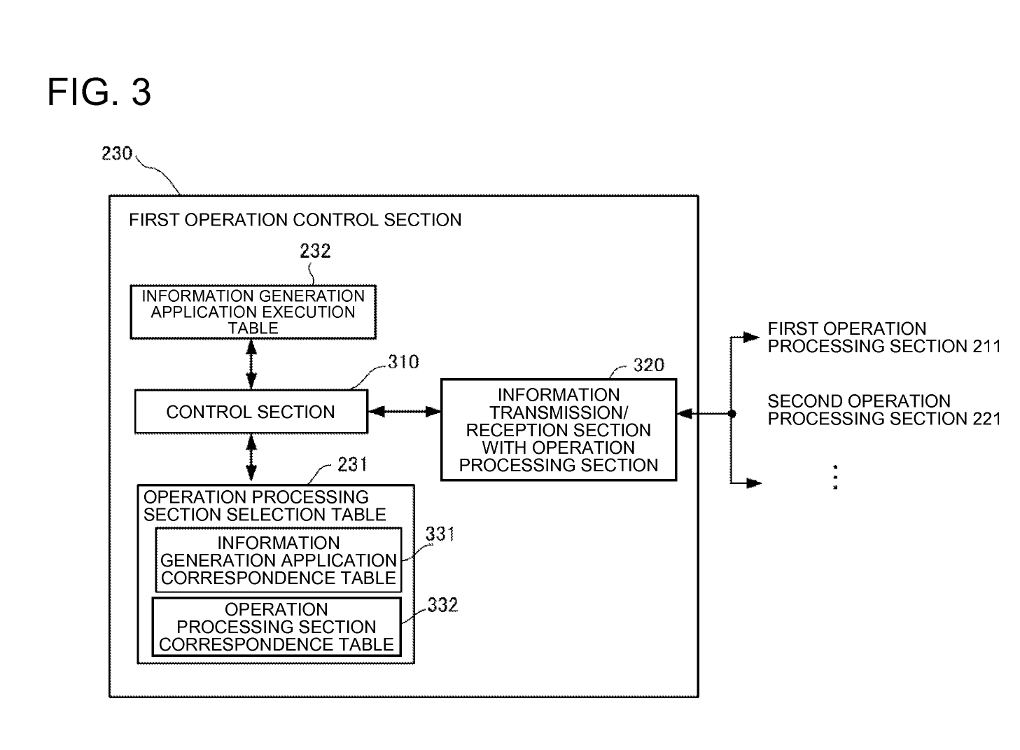

FIG. 3 is a block diagram showing the configuration of the first operation control section 230 according to the present embodiment.

The first operation control section 230 includes a control section 310 which controls the entire first operation control section 230. It should be noted that if the first operation control section 230 is a software module, the control section 310 may be a processor for controlling the entire information processing device 200. The first operation control section 230 includes an information transmission/reception section 320 with operation processing sections, for performing process communications with the operation processing sections including the first operation processing section 211 and the second operation processing section 221. The first operation control section 230 also includes an operation processing section selection table 231 to be referred to for selecting an operation processing section to be activated by the control section 310, and an information generation application execution table 232 which stores whether or not the respective information generation applications are in execution. In the present embodiment, the operation processing section selection table 231 stores an information generation application correspondence table 331 which stores the respective information generation applications and the platforms on which they are operable in association with each other, and an operation processing section correspondence table 332 which stores the respective operation processing sections and the platforms on which they are operable in association with each other. With these two tables, an information generation application activated by a user and an operation processing section which should be activated by the first operation control section 230 are determined.

### (Operation Processing Section Selection Table)

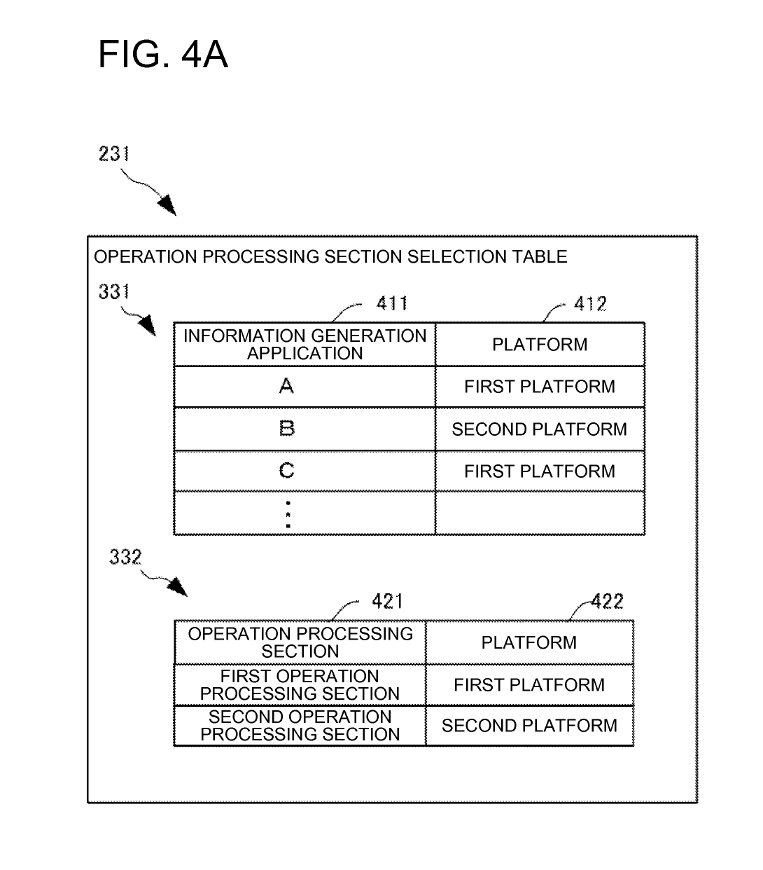

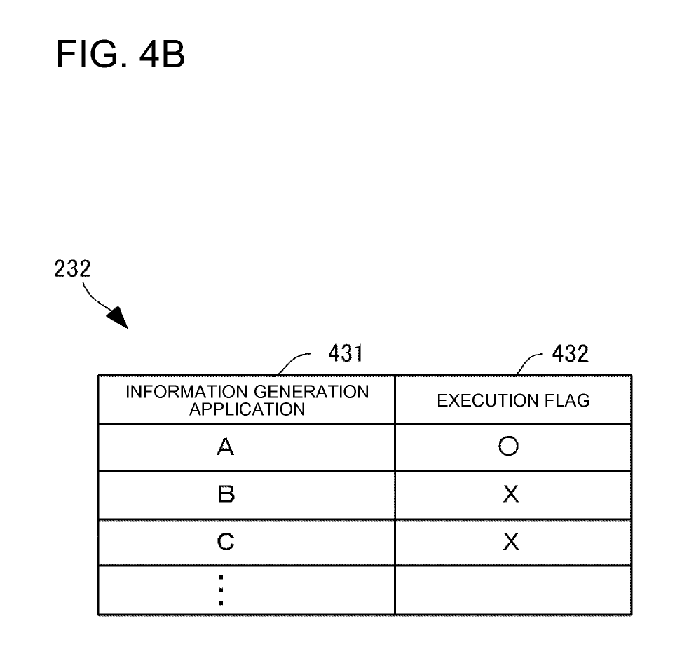

FIG. 4A is a diagram showing the configuration of the operation processing section selection table 231 according to the present embodiment.

The information generation application correspondence table 331 in the operation processing section selection table 231 stores platforms 412 in association with the respective information generation applications 411 operable thereon. For example, the information generation applications 212 for the first platform, shown in FIG. 2, are information generation applications “A” and “C” stored in the information generation application correspondence table 331. Further, the information generation application 222 for the second platform is an information generation application “B” stored in the information generation application correspondence table 331. On the other hand, the operation processing section correspondence table 332 in the operation processing section selection table 231 stores platforms 422 in association with the respective operation processing sections 421 operable thereon. In accordance with the information generation application activated by the user, the first operation control section 230 recognizes the operable platform from the information generation application correspondence table 331, and determines an operation processing section operable on the recognized platform according to the operation processing section selection table 231 (specifically, activates the operation processing section to thereby establish communications).

### (Information Generation Application Execution Table)

FIG. 4B is a diagram showing the configuration of the information generation application execution table 232 according to the present embodiment.

The information generation application execution table 232 stores execution flags 432 in association with the respective information generation applications 431 so as to represent whether or not they are in execution. The execution flag 432 shows “o” if the information generation application 431 is in execution and shows “x” if the information generation application 431 is not in execution.

### (Configuration of Operation Processing Section)

FIG. 5A is a block diagram showing the configuration of the operation processing section according to the present embodiment. It should be noted that between the first operation processing section 211 and the second operation processing section 221, only the platforms on which they are operable are different and the other function configurations and the processing are the same. As such, description will be given according to FIG. 5A which is in common.

The operation processing section 211 or 221 includes a control section 510 which controls the whole. The control section 510 includes an activated flag 511 representing that the own section is activated. It should be noted that if the operation processing section is a software module, the control section 510 may be a processor for controlling the entire information processing device 200. The operation processing section has the following function configuration sections in each of which the information flow is controlled by the control section 510.

FIG. 5B is a diagram illustrating the processing of the respective function configuration sections of the operation processing section according to the present embodiment. The processing content 502 of the respective function configuration sections 501 are described in association with each other.

First, an information transmission/reception section 520 with the operation control section, shown on the left side in FIG. 5A, performs transmission and reception of information with the first operation control section 230. For example, the information transmission/reception section 520 with the operation control section receives an activation instruction and a control instruction of the operation processing section, from the first operation control section 230. Further, the information transmission/reception section 520 with the operation control section exchanges a screen control instruction, an input control instruction, a drawing control instruction, and the like, with the first operation control section 230. Next, an information transmission/reception section 530 with an operation processing section of another device performs transmission and reception of information with the operation processing section of another device. For example, the information transmission/reception section 530 with the operation processing section of the other device exchanges screen information, input instruction information, drawing information, and the like, by network communications.

The function configuration sections, shown on the right side in FIG. 5A, include information acquisition section which acquires information of the user interface section 240 and an information output section which outputs information to the user interface section 240, in order to perform input and output of information with the user interface section 240.

A transmission screen acquisition section 540 acquires a screen generated by the information generation application, from the screen of the user interface section 240 in order to transmit it to the operation processing section of another device. The transmission screen display section 550 receives a screen generated by the information generation application of the other device, and reproduces it as a screen on the user interface section 240.

The input instruction information acquisition section 560 acquires input instruction evens from a pointing device, a keyboard, and the like on the information generation application, in order to transmit them to the operation processing section of another device. An input instruction information reflection section 570 reproduces the input instruction events from a pointing device, a keyboard, and the like on the information generation application of another device, on the user interface section 240.

A drawing information acquisition section 580 acquires information of lines and text drawn on the screen by the information generation application, in order to transmit it to the operation processing section of another device. A drawing information display section 590 receives information of lines and text drawn on the screen by the information generation application of another device, and reproduces it on the screen of the user interface section 240.

With these configurations, the operation processing section 211 or 221 acquires information of the user interface section 240 by the transmission screen acquisition section 540, the input instruction information acquisition section 560, and the drawing information acquisition section 580, and transmits it to the operation processing section of another device via the information transmission/reception section 530 with the operation processing section of the other device. Thereby, it is possible to share the information of the user interface section of another information processing device (another device) connected over the network, with the information of the user interface section of the present information processing device. In particular, an image displayed on the screen can be shared. Further, the operation processing section 211 or 221 receives information of the user interface section of another device via the information transmission/reception section 530 with the operation processing section of the other device, and reflects it on the user interface section 240 by the transmission screen display section 550, the input instruction information reflection section 570, and the drawing information display section 590. Thereby, it is possible to share the information of the user interface section 240 of the present information processing device, with the information of the user interface section of another information processing device connected over the network. In particular, an image displayed on the screen can be shared.

### <Operation Sequence>

Hereinafter, characteristic data exchanges between function configuration sections in the present embodiment will be described in sequence of operations. It should be noted that if the function configuration sections are software modules, data exchanges are performed by inter-process communications or exchanges between functions using arguments.

### (Generation of Information Generation Application Correspondence Table)

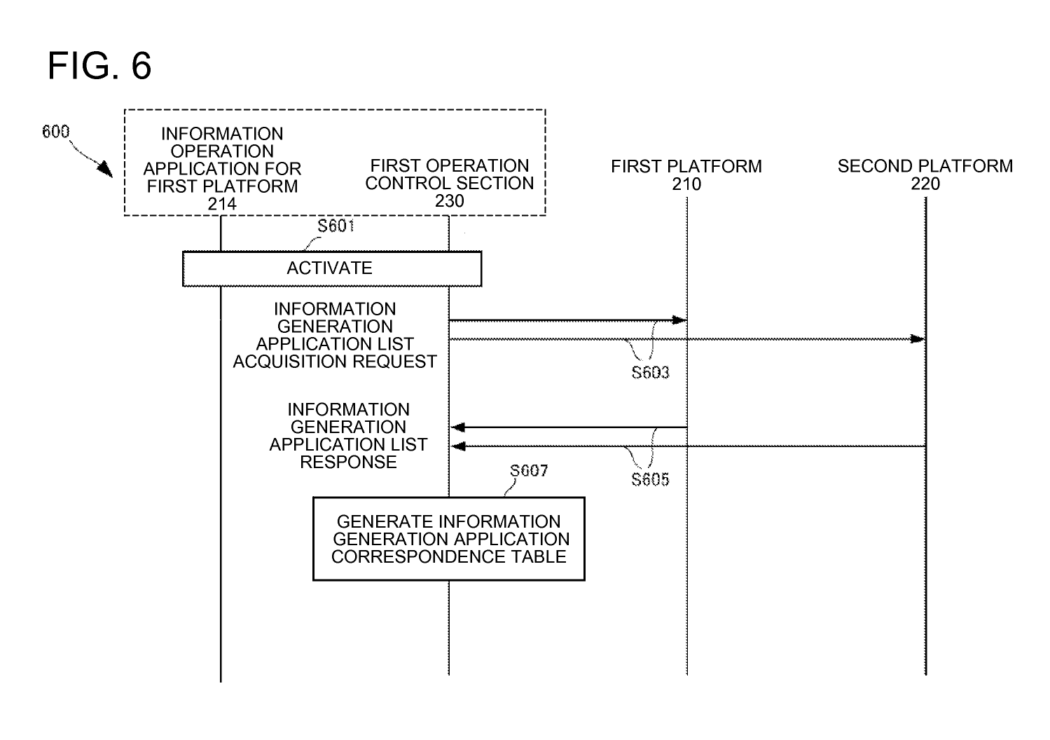

FIG. 6 is a sequence chart showing a generation procedure 600 of the information generation application correspondence table 331 by the first operation control section 230 according to the present embodiment. This processing is executed at the time when the first operation control section 230 is activated. For example, the processing is executed when the power is on or restarted, when an application is updated, when the first operation control section 230 is activated from the information operation application for the first platform, or the like.

First, at step S601, the information processing device 200 activates the information operation application 214 for the first platform and the first operation control section 230. At step S603, the first operation control section 230 requests the respective platforms (each of the platforms) operated by the present information processing device 200 for a list of applications which operate on each platform. Specifically, the first operation control section 230 requests the respective operation processing sections which perform processing with respect to the applications on the respective platforms, for a list of applications which operate on each platform. In the present embodiment, the first operation control section 230 inquires of the first platform 210 (first operation processing section 211) and the second platform 220 (second operation processing section 221) for a list of the information generation applications controlled by each platform.

At step S605, the first operation control section 230 receives a response regarding a list of the controlled information generation applications from the respective platforms (respective operation processing sections). Then, at step S607, the first operation control section 230 (control section 310) generates the information generation application correspondence table 331 based on the response.

### (Beginning of Use of Information Generation Application)

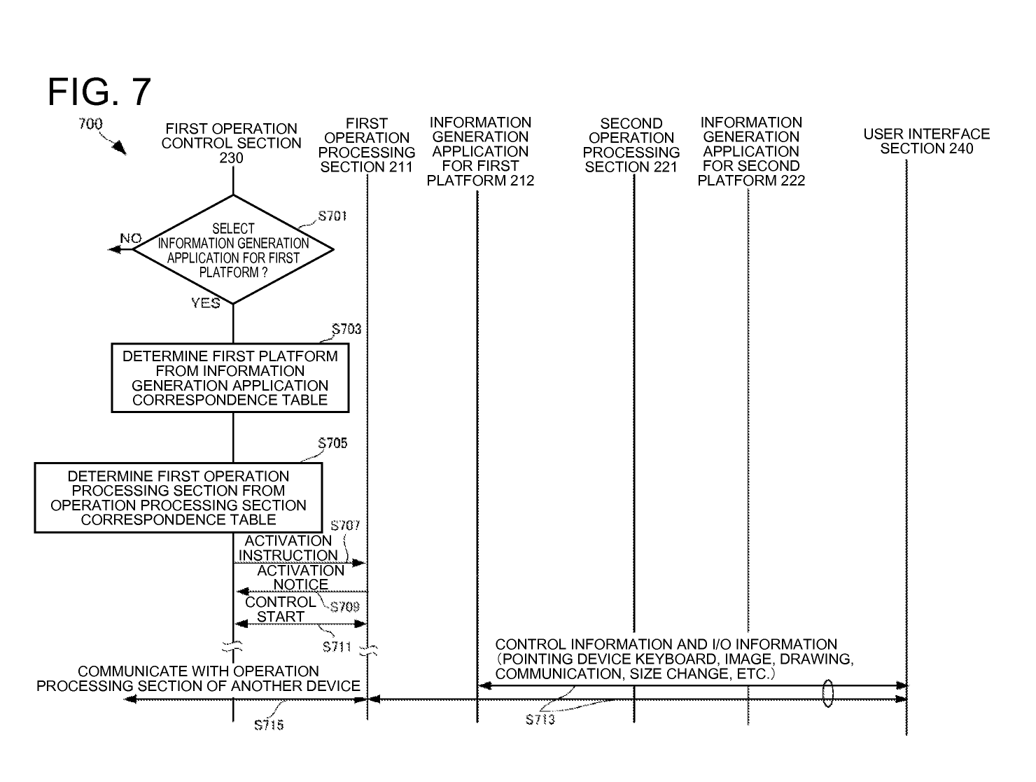

FIG. 7 is a sequence chart showing an operation procedure 700 of beginning to use the information generation application 212 for the first platform by the first operation control section 230 according to the present embodiment. This sequence is executed when a user activates the information generation application 212 for the first platform which operates on the first platform 210, from the user interface section 240 of the present information processing device 200.

First, at step S701, the first operation control section 230 (control section 310) determines whether or not the user selects and activates the information generation application 212 for the first platform. When determining that the information generation application 212 for the first platform is selected and started, the processing is moved to step S703, and the first operation control section 230 determines whether or not the information generation applications stored in the information generation application correspondence table 331 operates on the first platform 210. Then, at step S705, based on the determination result at step S703, the first operation control section 230 activates an operation processing section selected from the operation processing section correspondence table 332, and establishes communications. For example, the first operation control section 230 determines the first operation processing section 211 to be the operation processing section to be activated.

At step S707, the first operation control section 230 (information transmission/reception section 320 with the operation processing section) givens an activation instruction to the determined first operation processing section 211. At step S709, the first operation control section 230 waits for an activation notice of the first operation processing section 211, and upon receipt of the activation notice, after step S711, the first operation control section 230 starts controlling of the first operation processing section 211.

Then, at step S713, when an information is input from the user interface section 240, in accordance with the input information, the information generation application 212 for the first platform generates information on the first platform 210. Further, when an instruction regarding an operation such as transmission or reception of the generated information is made from the user interface section 240, the operation instruction information and the generated information are acquired by the first operation processing section 211. Then, at step S715, in the case of transmission to the operation processing section of another device, for example, transmission is made from the first operation processing section 211 to the operation processing section of the other device.

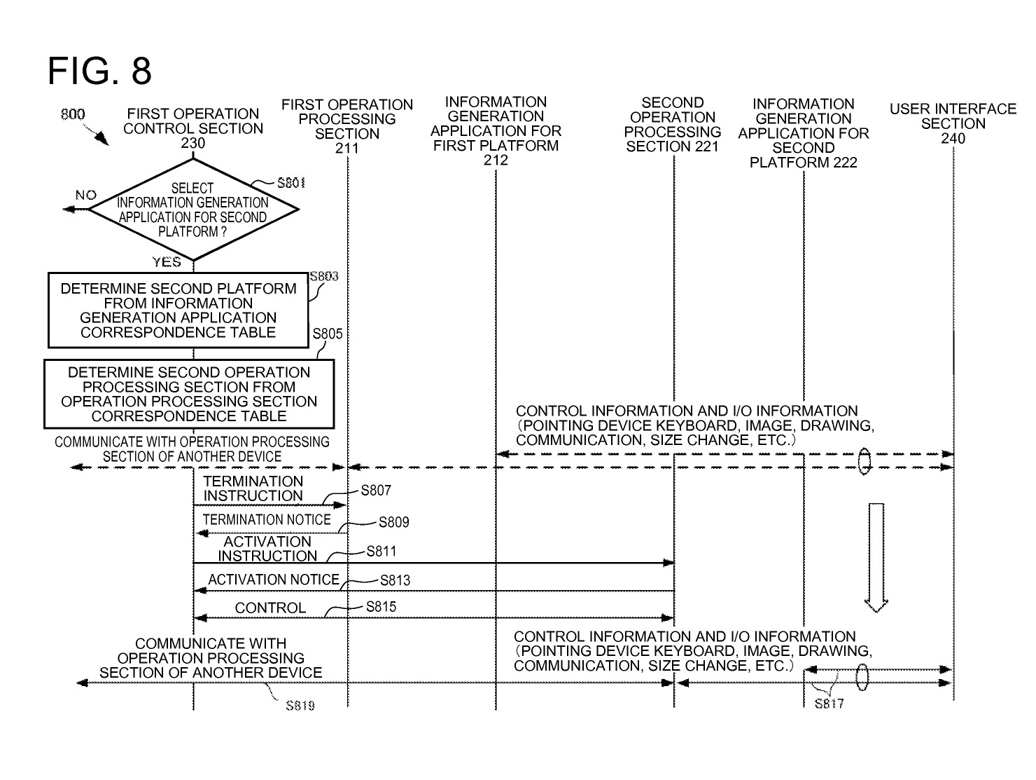

It should be noted that at step S701, if it is determined that the user did not activate the information generation application 212 for the first platform, or if it is determined that the user activated the information generation application 222 for the second platform, the processing is moved to step S801 in FIG. 8. Then, the first operation control section 230 selects and drives the second operation processing section 221. Then, the information generation application 222 for the second platform processes information input from the user interface section 240, and the second operation processing section 221 processes the operation instruction information input from the user interface section 240. To be specific, description will be given with reference to FIG. 8.

### (Change of Information Generation Application)

FIG. 8 is a sequence chart showing an operation procedure 800 of a change from the information generation application 212 for the first platform to the information generation application 222 for the second platform, by the first operation control section 230 according to the present embodiment. In accordance with the sequence in FIG. 7, it is assumed that the information generation application 212 for the first platform has been activated, and the first operation processing section 211 has been activated, as shown by the dashed lines in FIG. 8.

First, at step S801, the first operation control section 230 (control section 310) determines whether or not the user selects and activates the information generation application 222 for the second platform. If it is determined that the information generation application 222 for the second platform is selected and activated, the processing is moved to step S803, and the first operation control section 230 determines that it is operable on the second platform, 220 from the information generation application correspondence table 331. Next, at step S805, the first operation control section 230 determines the second operation processing section 221 to be an operation processing section to be activated, from the operation processing section correspondence table 332.

At step S807, as the platform on which the information generation application operates has been changed, the first operation control section 230 (information transmission/reception section 320 with the operation processing section) gives a termination instruction to the first operation processing section 211. Then, at step S809, the first operation control section 230 waits for a termination notice of the first operation processing section 211.

Upon receipt of the termination notice, at step S811, the first operation control section 230 gives an activation instruction to the determined second operation processing section 221. At step S813, the first operation control section 230 waits for an activation notice of the second operation processing section 221, and upon receipt of the activation notice, after step S815, the first operation control section 230 starts controlling of the second operation processing section 221.

Then, at step S817, when an information is input from the user interface section 240, in accordance with the information input, the information generation application 222 for the second platform generates information on the second platform 220. Further, when an instruction regarding an operation such as transmission or reception of the generated information is made from the user interface section 240, the operation instruction information and the generated information are acquired by the second operation processing section 221. Then, at step S819, in the case of transmission to an operation processing section of another device, transmission is made from the second operation processing section 221 to the operation processing section of the other device.

It should be noted that at step S801, if it is determined that the user did not activate the information generation application 222 for the second platform, it is determined whether or not an information generation application for another platform is activated. For example, if it is determined that the user activated the information generation application 212 for the first platform, as the first operation processing section 211 has been activated, processing by the first operation processing section 211 and the information generation application 212 for the first platform is continued.

### <Hardware Configuration of Information Processing Device>

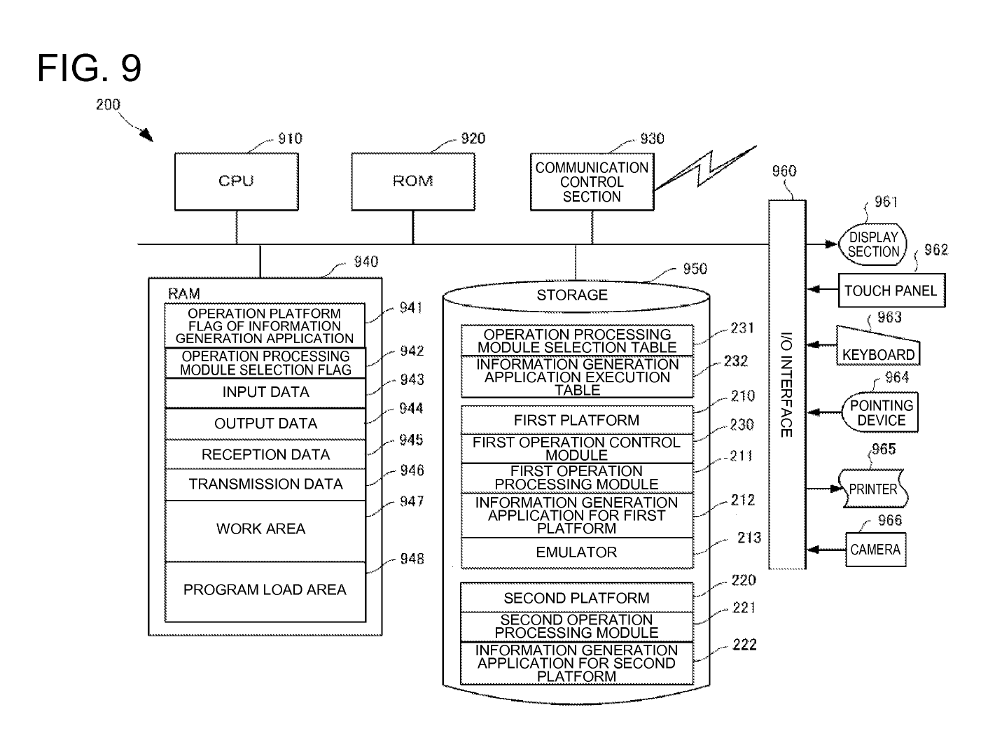

FIG. 9 is a block diagram showing the hardware configuration of the information processing device 200 according to the present embodiment.

In FIG. 9, a CPU 910 is a processor for arithmetic control, and executes a program to thereby implement the respective function configuration sections shown in FIGS. 2, 3, and 5A. A ROM 920 stores initial data, fixed data such as a program, and a program. Further, a communication control section 930 controls communications with other information processing devices over the network.

A RAM 940 is a random access memory which is used as a work area of a temporally storage by the CPU 910. In the RAM 940, a region for storing data required for implementing the present embodiment is secured. A reference numeral 941 denotes a flag showing the operation platform of an information generation application activated by the user. A reference numeral 942 denotes an operation processing module selection flag showing an operation processing module corresponding to the operation processing section, which is selected to be activated. In the present embodiment, it is a flag showing whether the module is a first operation processing module or a second operation processing module. A reference numeral 943 denotes input data input from an input device via an input/output interface 960. A reference numeral 944 denotes output data to be output to an output device via the input/output interface 960. A reference numeral 945 denotes reception data received from another information processing device over the network. A reference numeral 946 denotes transmission data to be transmitted to another information processing device over the network. A reference numeral 947 denotes a work area to be used for another type of processing by the CPU 910. A reference numeral 948 denotes a program load area for loading and executing a program or a module stored in a storage 950.

The storage 950 stores a data base and various types of parameters, or following data or program required for implementing the present embodiment. A reference numeral 231 denotes an operation processing module selection table corresponding to the operation processing section selection table 231. A reference numeral 232 denotes an information generation application execution table.

The storage 950 stores the following programs. 210 stores a program corresponding to the first platform. 230 stores a program module corresponding to the first operation control section 230 operable on the first platform 210. 211 stores a program module corresponding to the first operation processing section 211 operable on the first platform 210. 212 stores a program module corresponding to the information generation application for the first platform, operable on the first platform 210. 213 stores a program module corresponding to the emulator 213 operable on the first platform 210.

220 stores a program corresponding to the second platform. 221 stores a program module corresponding to the second operation processing section 221 operable on the second platform 220. 222 stores a program module corresponding to the information generation application for the second platform operable on the second platform 220.

The input/output interface 960 inputs information input from a touch panel 962, a keyboard 963, a pointing device 964, and a camera 966 which is an image pickup section, as digital data. Further, the input/output interface 960 outputs a generated display screen to a display section 961, and outputs print data to a printer 965. The input/output interface 960 and the input/output device constitute the user interface section 240.

It should be noted that FIG. 9 only shows data and programs indispensable for the present embodiment, and does not show data and programs not related to the present embodiment.

### <Processing Procedure of Information Processing Device>

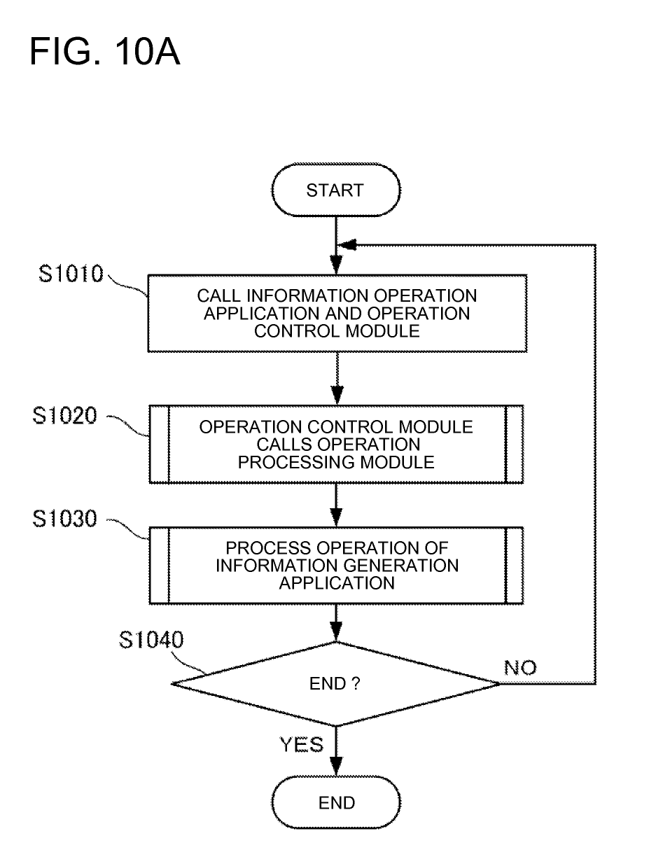

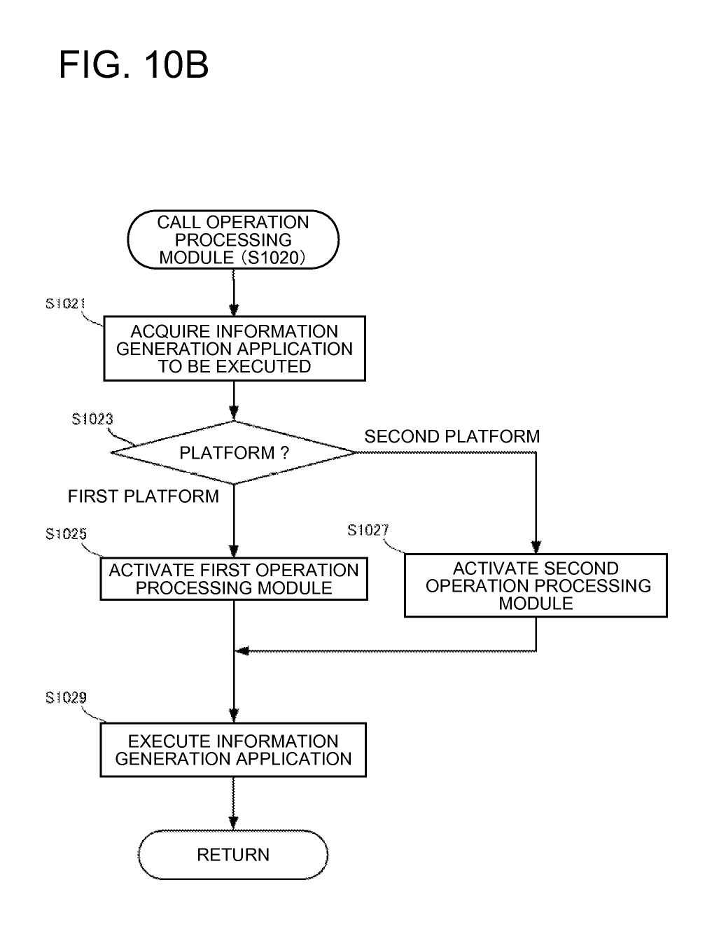

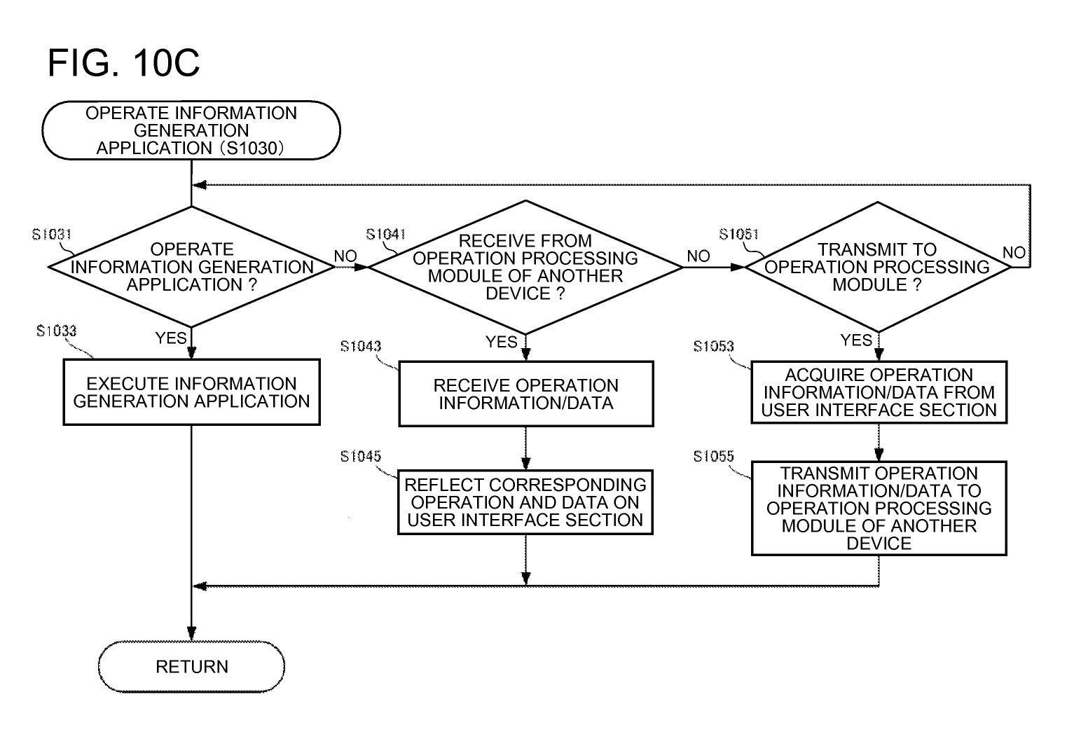

FIG. 10A is a flowchart showing the processing procedure of the information processing device 200 according to the present embodiment. This flowchart is executed by the CPU 910 in FIG. 9 with use of the RAM 940 to thereby implement the respective function configuration sections shown in FIGS. 2. 3. and 5A.

First, at step S1010, the CPU 910 calls an operation control module corresponding to the operation control section from the main application. It should be noted that calling of an operation control module is not limited to such processing. Next, at step S1020, the CPU 910 (operation control section) calls an operation processing module corresponding to the operation processing section, corresponding to the platform of the information generation application activated by the user by the operation control module (see FIG. 10B). Then, at step S1030, while generating information by the information generation application activated by the user, the CPU 910 (operation processing section) performs execution of an operation instruction by the called operation processing module (see FIG. 10C).

### (Calling of Operation Processing Module)

FIG. 10B is a flowchart showing the processing procedure of calling an operation processing module S1020 according to the present embodiment.

First, at step S1021, the CPU 910 (operation processing section) acquires the information generation application which is activated and executed by the user. At step S1023, the CPU 910 (operation control section) determines whether the platform on which the information generation application activated by the user is the first platform or the second platform, with reference to the information generation application correspondence table 331. If it is determined that the platform on which the application is operable is the first platform, the processing is moved to step S1025, and with reference to the operation processing section correspondence table 332, the CPU 910 activates the first operation processing module corresponding to the first operation processing section 211. On the other hand, if it is determined that the platform on which the application is operable is the second platform, the processing is moved to step S1027, and with reference to the operation processing section correspondence table 332, the CPU 910 (operation control section) activates the second operation processing module corresponding to the second operation processing section 221. Then, at step S1029, the CPU 910 (operation processing section) starts execution of the information generation application activated by the user, and returns (moves to step S1030 in FIG. 10A).

### (Operation of Information Generation Application)

FIG. 10S is a flowchart showing the processing procedure of the information generation application operation S1030 according to the present embodiment.

First, at step S1031, the CPU 910 (operation processing section) determines whether or not the operation in the information generation application activated at step S1029 is executed. For example, text inputting and image inputting for generating information correspond to this operation. At step S1031, if it is determined that the operation in the information generation application is not executed (step S1031: No), at step S1041, the CPU 910 (information transmission/reception section with an operation processing section) determines whether or not information is received from an operation processing module corresponding to an operation processing section of another device. At step S1041, if it is determined that information is not received from the operation processing module of the other device (step S1041: No), at step S1051, the CPU 910 (information transmission/reception section with an operation processing section) determines whether information is transmitted from the operation processing module corresponding to the operation processing section of the present information processing device 200, to the information processing module of the other device. It should be noted that the information to be transmitted or received described above include information generated by the information generation application and/or operation instruction information with respect to the information generated. At step S1051, if it is determined that information is not transmitted to the operation processing module of the other device (step S1051: No), the processing is returned to step S1031.

On the other hand, at step S1031, if it is determined that the operation is an operation of the information generation application (step S1031: Yes), the processing is moved to step S1033, and the CPU 910 executes the information generation application and proceeds generation of information.

At step S1041, if it is determined that information is received from the operation processing module of another device (step S1041: Yes), the processing is moved to step S1043, and the CPU 910 (information transmission/reception device with an operation processing section) receives operation information and/or data from the operation processing module of the other device. Then, at step S1045, the CPU 910 (operation processing section) reflects the received data and operation information on the user interface section 240.

Further, at step S1051, if it is determined that information is transmitted from the operation processing module of the present information processing device 200 to an operation processing module of another device (step S1051: Yes), the processing is moved to step S1053, and the CPU 910 acquires operation information and/or data from the user interface section 240. Then, at step S1055, the CPU 910 (Information transmission/reception section with the operation processing section) transmits the acquired operation information and/or data to the operation processing module of the other device.

### Third Exemplary Embodiment

Next, an information processing device according to a third exemplary embodiment of the present invention will be described. The information processing device according to the present embodiment is different from that of the second exemplary embodiment in that an information operation application and an operation control section operate on the second platform. Other configurations and operations which are the same as those of the second exemplary embodiment are denoted by the same reference numerals, and the detailed description thereof is not repeated herein. According to the present embodiment, even in the case where the operation control section is on the second platform, a user is able to generate information and perform operation even if the information generation application is switched during information generation.

### <Configuration of Information Processing Device>

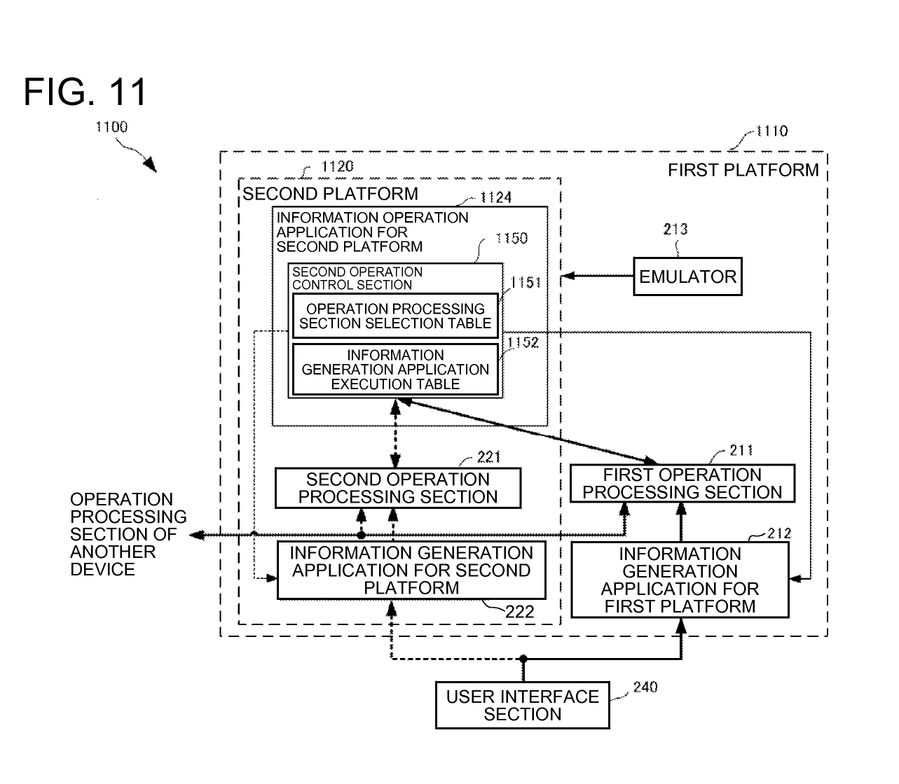

FIG. 11 is a block diagram showing the configuration of an information processing device 1100 according to the present embodiment. In FIG. 11, the function configuration sections which are the same as those in FIG. 2 of the second exemplary embodiment are denoted by the same reference numerals, and the description thereof is not repeated herein.

In FIG. 11, an information operation application 1124 for the second platform operates on the second platform 1120. As such, the operation control section also operates on the second platform 1120 as a second operation control section 1150. The configurations of an operation processing section selection table 1151 and an information generation application execution table 1152 included in the second operation control section 1150 are the same as those shown in FIGS. 3 and 4 of the second exemplary embodiment.

Although the present embodiment has a difference that the second operation control section 1150 operates on the second platform 1120, an operation of selecting and activating the operation processing section corresponding to the platform on which the information generation application activated by the user operates is the same, and the operational effect thereof is the same as that of the second exemplary embodiment.

### Fourth Exemplary Embodiment

Next, an information processing device according to a fourth exemplary embodiment of the present invention will be described. The Information processing device according to the present embodiment is different from the second exemplary embodiment in that the platform is limited to an operation system (hereafter referred to as OS) and the respective functional elements are implemented by software, whereby the device is described as a specific configuration. In particular, in the present embodiment, application to the OS based on the different numbers of bits will be described. Other configurations and operations which are the same as those of the second exemplary embodiment are denoted by the same reference numerals, and the detailed description thereof is not repeated herein. According to the present embodiment, in an environment in which a 32-bit OS is operable on a 64-bit OS via an emulator, even if the 32-bit OS application and the 64-bit OS application are switched and activated during communications by the 32-bit OS web browser, a user is able to continue generation of information and operation seamlessly.

It should be noted that although the present embodiment shows an example using different numbers of bits, the present invention is applicable to OSs having different command systems, or OSs which are different depending on the models or manufacturers.

### <Configuration of Information Processing Device>

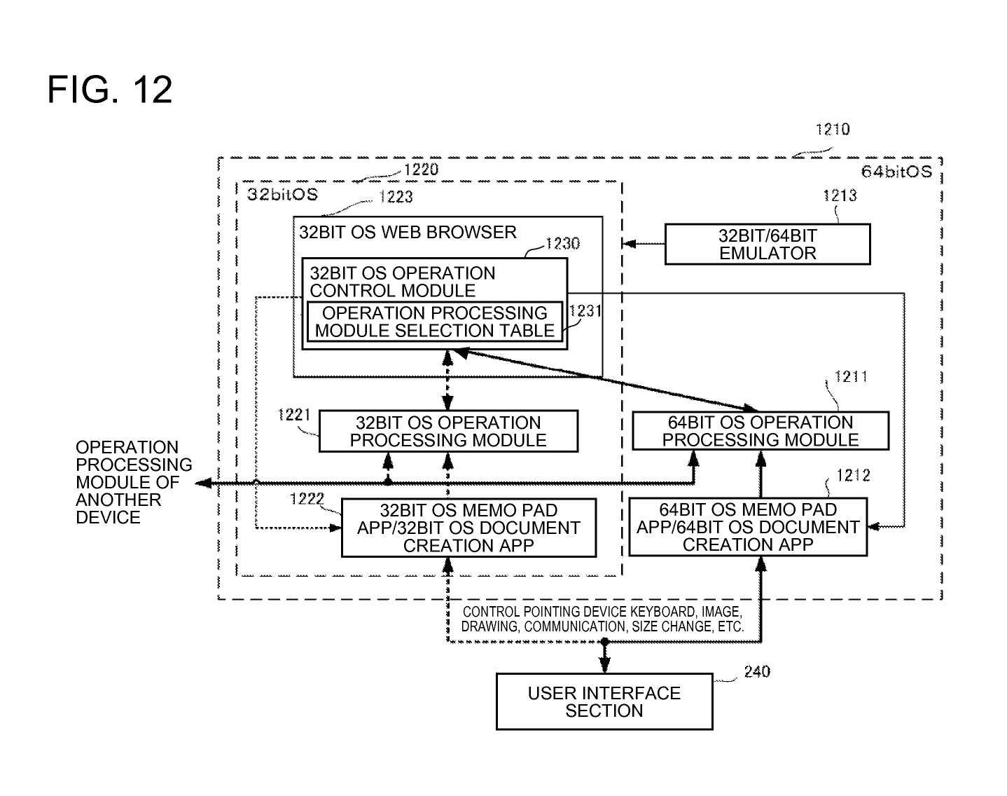

FIG. 12 is a block diagram showing the configuration of an information processing device 1200 according to the present embodiment. In FIG. 12, processing is described clearly by replacing the configuration of the third exemplary embodiment with specific modules and applications, particularly.

In FIG. 12, the first platform shown in FIGS. 2 and 11 is limited to a specific 64-bit OS 1210. Further, the second platform is limited to a specific 32-bit OS 1220. Corresponding to them, the modules and applications which operate on the respective OSs are noted as “32-bit OS” and “64-bit OS”, respectively.

In the present embodiment, the second application shown in FIGS. 2 and 11 is limited to a specific 32-bit OS web browser 1223. Further, the information generation application shown in FIGS. 2 and 11 is limited to a specific memo pad application and a document creation application. A 32-bit OS memo pad application/32-bit OS document creation application 1222 operable on the 32-bit OS 1220 and a 64-bit OS memo application/64-bit OS document creation application 1212 operable on the 64-bit OS 1210 are prepared.

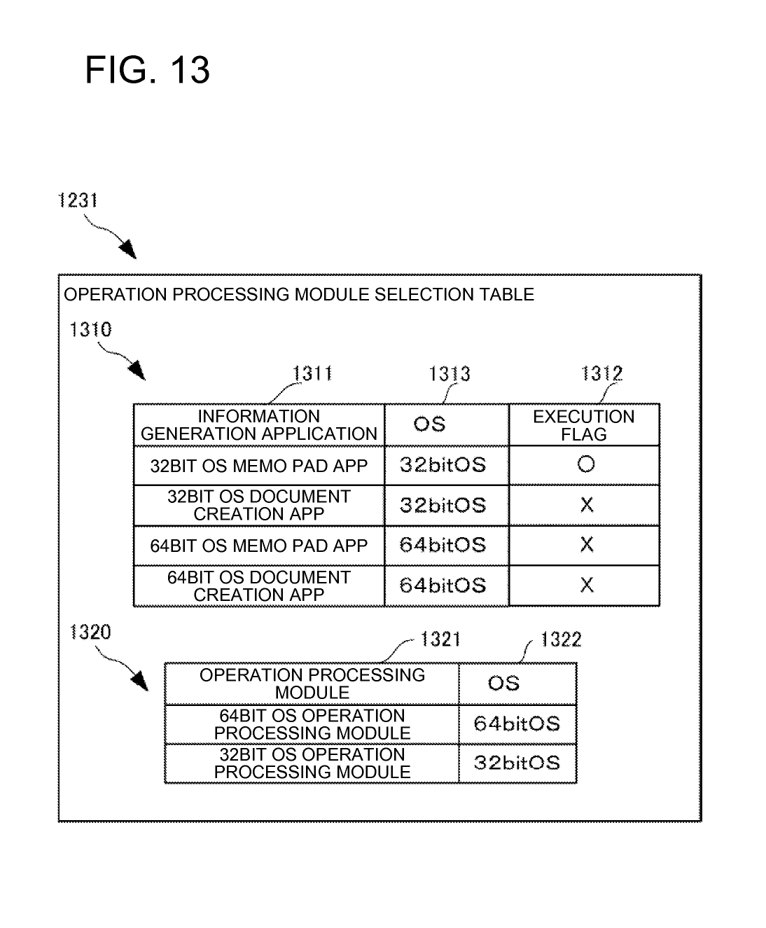

The configuration of the present embodiment corresponds to FIG. 11 of the third exemplary embodiment. As the 32-bit OS web browser 1223 operates on the 32-bit OS 1220, a 32-bit OS operation control module 1230 is prepared. The 32-bit OS operation control module 1230 includes an operation processing module selection table 1231. The present embodiment describes a configuration in which the operation processing module selection table 1231 includes execution flags showing the information generation applications in execution (see FIG. 13). Further, as operation processing modules selected and driven by the 32-bit OS operation control module 1230, a 64-bit OS operation processing module 1211 and a 32-bit OS operation processing module 1221 are prepared.

### (Operation Processing Section Selection Table)

FIG. 13 is a diagram showing the configuration of the operation processing module selection table 1231 according to the present embodiment.

An information generation application correspondence table 1310 in the operation processing module selection table 1231 stores the respective information generation applications 1311, OSs 1313 on which the applications are operable, and execution flags 1312, in association with each other. On the other hand, an operation processing module correspondence table 1320 in the operation processing module selection table 1231 stores the respective operation processing modules 1321 and operable OSs 1322 on which the modules are operable, in association with each other. In the example of FIG. 13, a 32-bit OS memo pad application is in execution (that is, an execution flag 1312 is “o”), and a 32-bit OS document creation application, a 64-bit OS memo application, and a 64-bit OS document creation application is not executed (that is, execution flag 1312 is “x”).

### <Hardware Configuration of Information Processing Device>

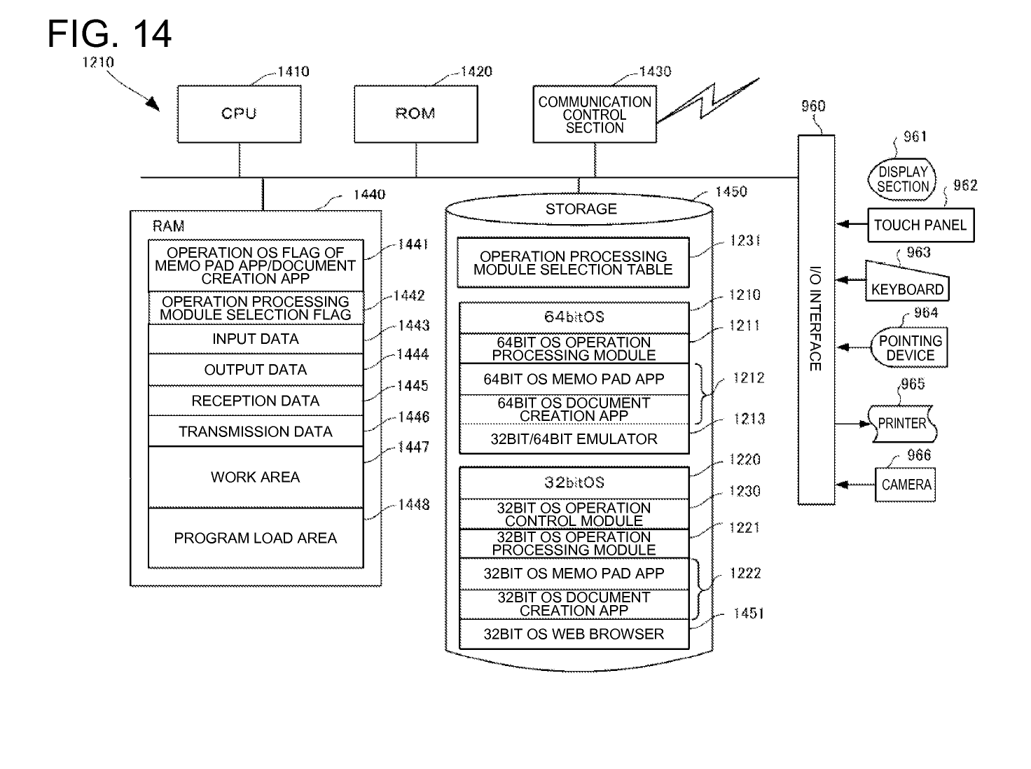

FIG. 14 is a block diagram showing the hardware configuration of the information processing device 1200 according to the present embodiment.

In FIG. 14, a CPU 1410 is a processor for arithmetic control, which executes a program to thereby implement respective function configuration sections in FIG. 12. A ROM 1420 stores initial data, fixed data such as a program, and a program. Further, a communication control section 1430 controls communications with other information processing devices over the network.

A RAM 1440 is a random access memory which is used as a work area of a temporally storage by the CPU 1410. In the RAM 1440, a region for storing data necessary for implementing the present embodiment is secured. A reference numeral 1441 denotes a flag showing the operation platform of a memo pad application/document creation application activated by a user. A reference numeral 1442 denotes an operation processing module selection flag showing the operation processing module selected to be activated. In the present embodiment, is it a flag showing whether a 64-bit OS operation processing module or a 32-bit OS operation processing module. A reference numeral 1443 denotes input data input from an input device via the input/output interface 960. A reference numeral 1444 denotes output data to be output to an output device via the input/output interface 960. A reference numeral 1445 is received data received from another information processing device over the network. A reference numeral 1446 denotes transmission data to be transmitted to another information processing device over the network. A reference numeral 1447 denotes a work area which is used by the CPU 1410 for other processing. A reference numeral 1448 represents a program load area for loading and executing a program or a module stored in a storage 1450.

The storage 1450 stores a database, various kinds of parameters, or the following data or programs necessary for implementing the present embodiment. A reference numeral 1231 denotes an operation processing module selection table.

The storage 1450 stores the following programs. 1210 stores a 64-bit OS corresponding to the first platform. 1211 stores a 64-bit OS operation processing module operable on the 64-bit OS 1210. 1212 stores a 64-bit OS memo pad application and a 64-bit OS document creation application which are operable on the 64-bit OS 1210. 1213 stores a 32-bit/64-bit emulator operable on the 64-bit OS 1210.

1220 stores a 32-bit OS corresponding to the second platform. 1230 stores a 32-bit OS operation control module operable on the 32-bit OS 1220. 1221 stores a 32-bit OS operation processing module operable on the 32-bit OS 1220. 1222 stores a 32-bit OS memo application and a 32-bit OS document creation application which are operable on the 32-bit OS 1220. 1451 stores a 32-bit OS web browser (e.g., Internet Explorer).

As the input/output interface 960 and input/output devices connected thereto are the same as those shown in FIG. 9, they are denoted by the same reference numerals and the description thereof is not repeated herein.

It should be noted that FIG. 14 only shows data and programs indispensable for the present embodiment, and does not show data and programs not related to the present embodiment.

### <Processing Procedure of Information Processing Device>

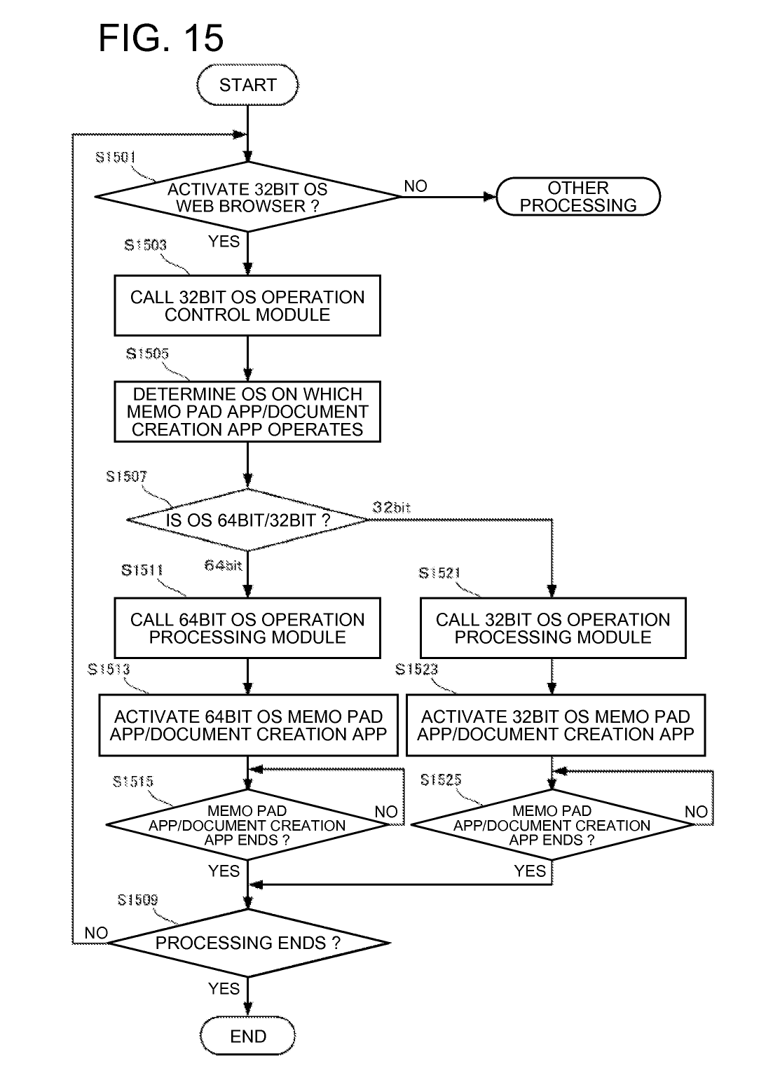

FIG. 15 is a flowchart showing the processing procedure of the information processing device 1200 according to the present embodiment.

First, at step S1501, the CPU 1410 determines whether the 32-bit OS web browser 1223 is activated. If determining that the 32-bit OS web browser 1223 is not activated (step S1501: No), the CPU 1410 performs another processing.

On the contrary, if the CPU 1410 determines that the 32-bit OS web browser 1223 is activated (step S1501: Yes), the processing is moved to step S1503, and the CPU 1410 calls the 32-bit OS operation control module 1230. At step S1505, the CPU 1410 determines (recognizes) the OS on which the memo pad application/document creation application activated by the user operates, with reference to the information generation application correspondence table 1310. Then, at step S1507, the CPU 1410 determines whether the OS is 64 bits or 32 bits.

If the CPU 1410 determines that the OS is a 64-bit OS (step S1507: 64 bits), the processing is moved to step S1511, and the CPU 1410 calls the 64-bit OS operation processing module 1211. At step S1513, the CPU 1410 activates the 64-bit OS memo pad application/document creation application 1212 which is the application that the user instructed to activate. Then, at step S1515, the CPU 1410 waits for the end of the 64-bit OS memo pad application/document creation application 1212 (determines whether or not it ends). During this period, if there is any operation instruction such as transmission of a memo pad or a document created by the 64-bit OS memo pad application/document creation application 1212, operation processing is performed by the 64-bit OS operation processing module 1211. Further, if any other processing program is activated during this period, the CPU 1410 performs such processing. When the CPU 1410 determines that the 64-bit OS memo pad application/document creation application ends (step S1515: Yes), the processing is moved to step S1509.

On the other hand, if the CPU 1410 determines that the OS is a 32-bit OS (step S1507: 32 bits), the processing is moved to step S1521, and the CPU 1410 calls the 32-bit OS operation processing module 1221. At step S1523, the CPU 1410 activates the 32-bit OS memo pad application/document creation application 1222 which is the application that the user instructed to activate. Then, at step S1525, the CPU 1410 waits for the end of the 32-bit OS memo pad application/document creation application 1222 (determines whether or not it ends). During this period, if there is any operation instruction for transmission of a memo pad or a document created by the 32-bit OS memo pad application/document creation application, processing for such an operation is performed by the 32-bit OS operation processing module 1221. Further, if any other processing program is activated during this period, the CPU 1410 performs such processing. When the CPU 1410 determines that the 32-bit OS memo pad application/document creation application ends (step S1525: Yes), the processing is moved to step S1509.

At step S1509, the CPU 1410 determines whether or not the processing ends (whether or not ending is instructed). If the CPU 1410 determines that the processing has not ended (step S1509: No), the processing is moved to step S1501, and the CPU 1410 repeats the processing. On the contrary, if the CPU 1410 determines that the processing has ended (step S1509: Yes), the CPU 1410 ends the processing. It should be noted that in the case of calling a 64-bit OS operation control module by the 64-bit OS web browser as in the second exemplary embodiment, the same processing is performed.

### Fifth Exemplary Embodiment

Next, an information processing device according to a fifth exemplary embodiment of the present invention will be described. The information processing device according to the present embodiment is different from that of the second exemplary embodiment in that the operation control section can be activated on both platforms. Detailed description of other configurations and operations, which are the same as those of the second exemplary embodiment, is not provided herein. According to the present embodiment, even if an information operation application is activated on either platform, a user is able to continue generation of information and operation seamlessly with respect to switching and activation of an application.

### <Configuration of Information Processing Device>

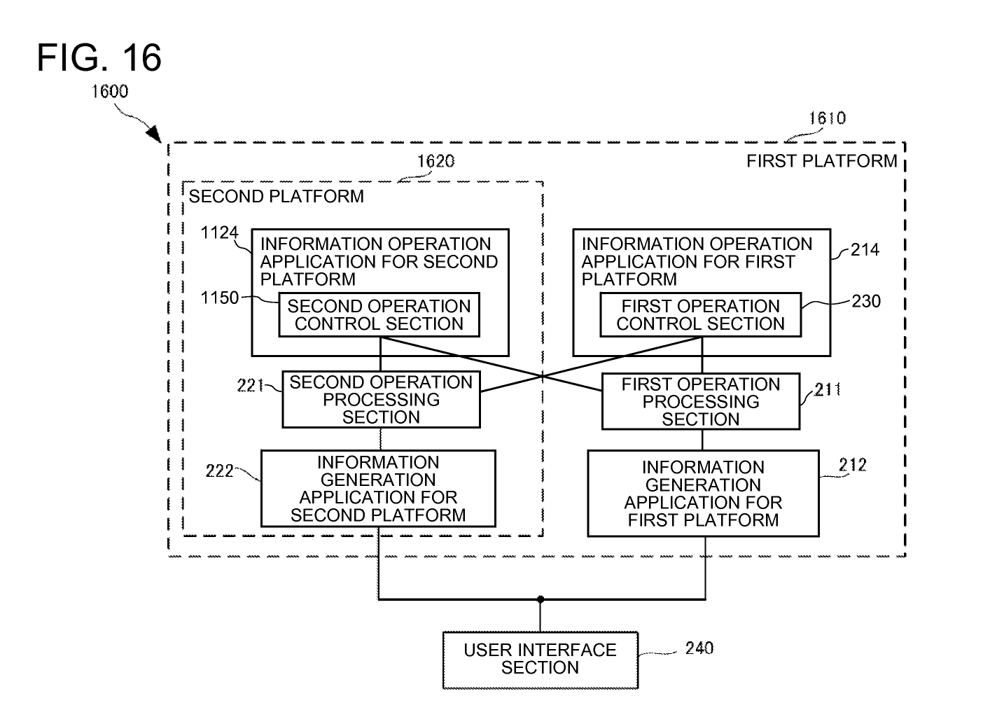

FIG. 16 is a block diagram showing the configuration of an information processing device 1600 according to the present embodiment. It should be noted that in the information processing device 1600 shown in FIG. 16, as the operation processing sections and the information generation applications to be prepared are the same as those in FIGS. 2 and 11, they are denoted by the same reference numerals and the description thereof is not repeated herein.

In FIG. 16, as in the second exemplary embodiment, for a first platform 1610, the information operation application 214 for the first platform is prepared, and the first operation control section 230 to be activated from the information operation application 214 for the first platform is also prepared. Meanwhile, as in the third exemplary embodiment, for a second platform 1620, the information operation application 1124 for the second platform is prepared, and the second operation control section 1150 to be activated from the information operation application 1124 for the second platform is also prepared.

In such a configuration, both the first operation control section 230 and the second operation control section 1150 determine on which of the platforms the information generation applications operate, and select and activate operation processing sections which operate on the same platforms from the first operation processing section 211 and the second operation processing section 221.

Accordingly, it is possible to select and drive an operation processing section suitable for an information generation application from information operation applications which operate on the first platform 1310 and the second platform 1620.

### <Processing Procedure of Information Processing Device>

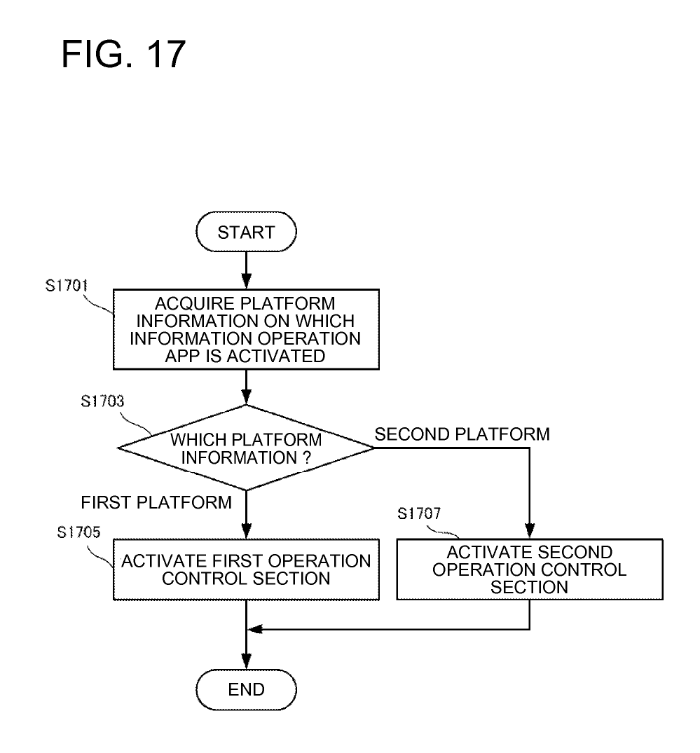

FIG. 17 is a flowchart showing the processing procedure of the information processing device 1600 according to the present embodiment. It should be noted that although the hardware configuration of the information processing device 1600 is not shown, this flowchart is executed by the CPU as shown in FIG. 9 or 14 by using a RAM to thereby implement the respective function configuration sections of FIG. 16.

The present embodiment is different from the second exemplary embodiment and the third exemplary embodiment in that the first operation control section 230 and the second operation control section 1150 select and activate the first operation processing section 211 and the second operation processing section 221 on both the first platform 1610 and the second platform 1620. As the algorithm to select and activate the first operation processing section 211 and the second operation processing section 221 is the same as that of the second exemplary embodiment and the third exemplary embodiment, FIG. 17 only shows selection and driving of the first operation control section 230 and the second operation control section 1150.

At step S1701, the information processing device 1600 (e.g., the CPU (not shown) of the information processing device 1600) acquires platform information on which an information operation application is activated. Then, at step S1703, the information processing device 1600 determines whether the platform information is of the first platform or the second platform. If the information processing device 1600 determines that it is of the first platform (step S1703: first platform), the processing is moved to step S1705 and the information processing device 1600 activates the first operation control section 230. On the other hand, if it is determined that the information is of the second platform (step S1703: second platform), the processing is moved to step S1707, and the information processing device 1600 activates the second operation control section 1150.

As the processing after activating either operation control section is the same as in the second exemplary embodiment and the third exemplary embodiment, the description thereof is not repeated herein.

### Sixth Exemplary Embodiment

Next, an information processing device according to a sixth exemplary embodiment will be described. The information processing device according to the present embodiment is an example in which the information processing device of the second to fifth exemplary embodiment is applied to a remote consultation system in which a client terminal and an operator terminal are connected over a network and the system operates while sharing the screens and operations with each other. Regarding part to which the same functions as those of the second to fifth exemplary embodiments can be applied, the details thereof are not repeated herein. According to the present embodiment, in the case where the operator terminal is a 64-bit computer, regardless of the client terminal being a 32-bit computer or a 64-bit computer, the operator is able to continue generation of information and operation seamlessly by switching a 64-bit OS application and a 32-bit OS application.

### <Configuration of Remote Consultation System>

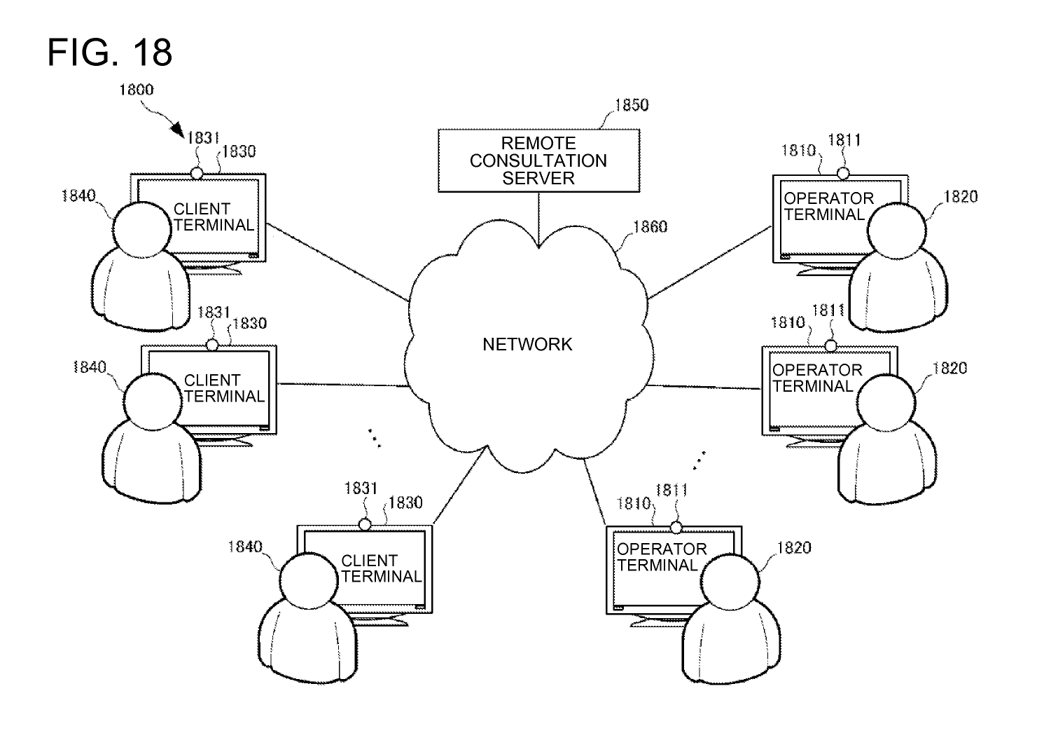

FIG. 18 is a block diagram showing the configuration of a remote consultation system 1800 which is an information processing system according to the present embodiment.

The remote consultation system 1800 includes an operator terminal 1810 which is operated by an operator 1820 who gives counsel over a network 1860, and a client terminal 1830 which is operated by a client 1840. The operator terminal 1810 and the client terminal 1830 are provided with cameras 1811 and 1831.

The operator terminal 1810 and the client terminal 1830 are connected with a remote consultation server 1850 which provides information shared by the operator and the client. While the remote consultation server 1850 provides processing for sharing information by the operator terminal 1810 and the client terminal 1830, as this is not a unique feature of the present embodiment, the description thereof is not provided herein.

### <Configurations of Operator Terminal and Client Terminal>

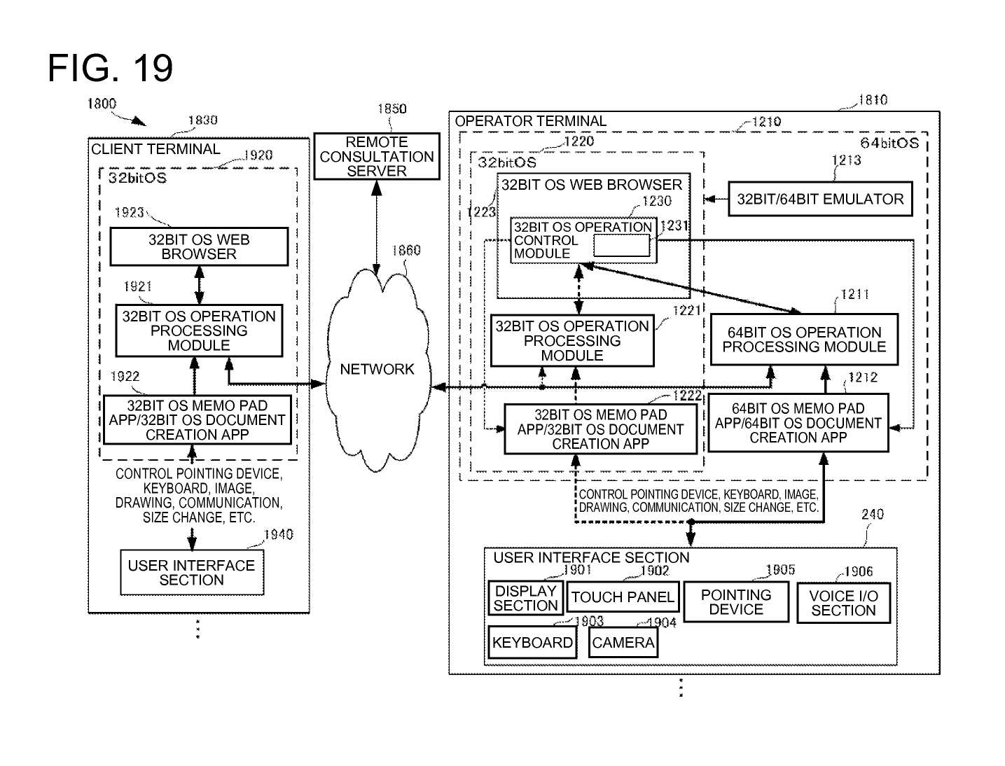

FIG. 19 is a block diagram showing the configurations of the operator terminal 1810 and the client terminal 1830 in the remote consultation system 1800 according to the present embodiment. The operator terminal 1810 and the client terminal 1830 in FIG. 19, which correspond to FIG. 12, are shown in more specific configurations.

In FIG. 19, as the operator terminal 1810 has the same configuration as that in FIG. 12, the detailed description thereof is not repeated herein. As such, a web browser as an information operation application operates on the 32-bit OS 1220, and as for the operation control module, the 32-bit OS operation control module 1230 operates on the 32-bit OS 1220. The 32-bit OS operation control module 1230 selects an operation processing module to be activated according to the bits of the memo pad application/document creation application.

However, in the user interface section 240 of FIG. 19, exemplary input/output devices which are required for use by the operator are shown. For example, the user interface section 240 includes a display 1901, a touch panel 1902, a keyboard 1903, a camera 1904, a pointing device 1905, and a voice input/output section 1906.

On the other hand, the client terminal 1830 is a device which only operates on the 32-bit OS 1920. As such, the client terminal 1830 does not need an operation control module for selecting and activating a 32-bit OS operation processing module and a 64-bit OS operation processing module. Basically, it is only necessary that a 32-bit OS operation processing module 1921 operates. The client terminal 1830 includes a 32-bit OS memo pad application/32-bit OS document creation application 1922 and a 32-bit OS web browser 1923. The user interface section 1940 includes an input/output device corresponding to the user interface section 240. Information from the user interface section 1940 is used for memo pads and document creation in the 32-bit OS memo pad application/32-bit OS document creation application 1922. Further, transmitted information and operation instruction information from the user interface section 1940 are acquired by a 32-bit OS operation processing module 1921, and are transmitted and received by the 32-bit OS operation processing module 1221 or the 64-bit OS operation processing module 1211 of the operator terminal 1810. In this way, information is shared between the client and the operator.

### <Display Screens of Operator Terminal and Client Terminal>

Hereinafter, a simple operation relating to the present embodiment in the remote consultation system 1800 will be described with use of display screens.

### (Sharing of Content)

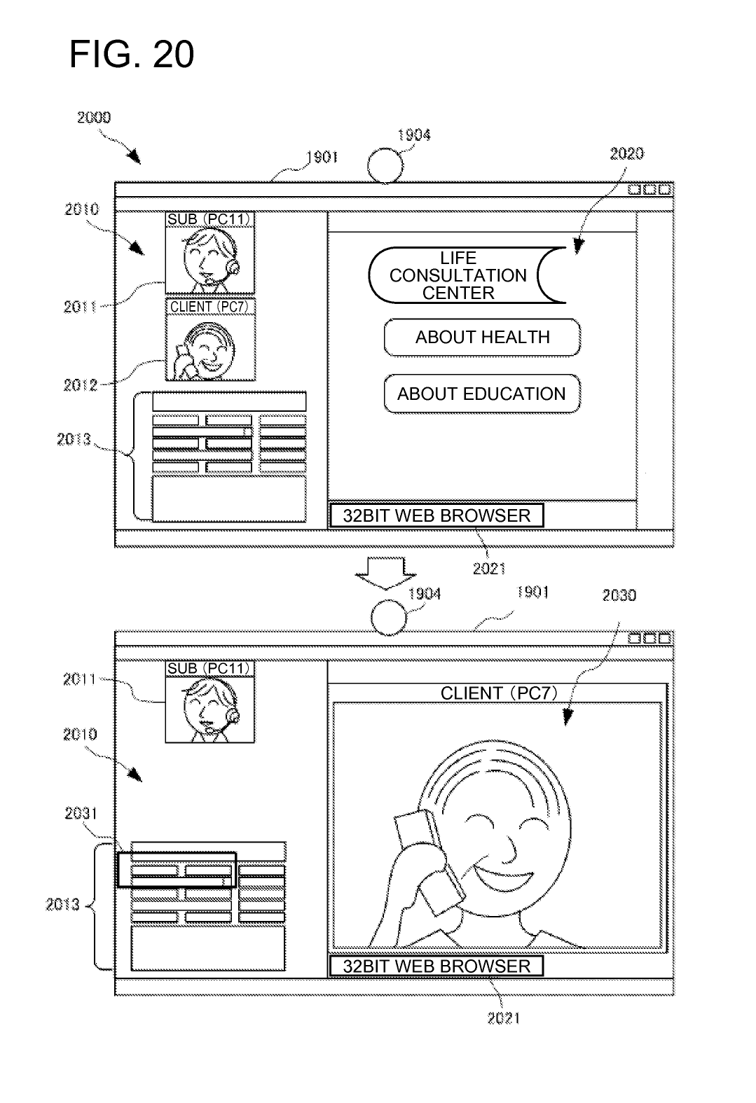

FIG. 20 is a diagram showing an exemplary display screen 2000 of the operator terminal 1810 according to the present embodiment.

In FIG. 20, a display screen of the display section 1902 is shown. On top of the display section 1902, the camera 1904 is provided. The display screen is divided into two right and left areas.

In the upper drawing of FIG. 20, a left-side area 2010 is an area for video display captured by the cameras and for an operation menu 2013. The upper video display is a self video 2011 of the operator 2011 in operation, and the lower video display is a video 2012 of the client which is a communication counterpart. In the upper drawing of FIG. 20, a right-side area 2020 is a shared content display area which is shared by the operator and the client. The remote consultation server 1850 transmits a shared content in synchronization to the operator terminal 1810 and the client terminal 1830, whereby the operator and the client are able to share the same content. This means that the remote consultation server 1850 controls the operation of the transmission screen display section 550, in FIG. 5A, such that the operation processing module of the operator terminal 1810 and the operation processing module of the client terminal 1830 are in synchronization with each other. 2021 shows that the 32-bit OS web browser operates on the operator terminal 1810. It should be noted that as the display denoted by 2021 is for explanation, the display is not necessary.

The lower drawing of FIG. 20 shows a display screen when a zoom display of the video captured by the camera of the communication counterpart is selected (not shown). In the lower drawing of FIG. 20, the video of the client, who is the communication counterpart, captured by the camera disappears from the left-side area 2010, and the zoomed video of the client is displayed on the right-side area 2030. In this case, in the client terminal 1830, the transmission screen acquisition section 540, in FIG. 5A, acquires the video from the camera, and the video is displayed by the transmission screen display section 550, in FIG. 5A, in the operator terminal 1810.

### (Activation of Memo Pad Application and Document Creation Application)

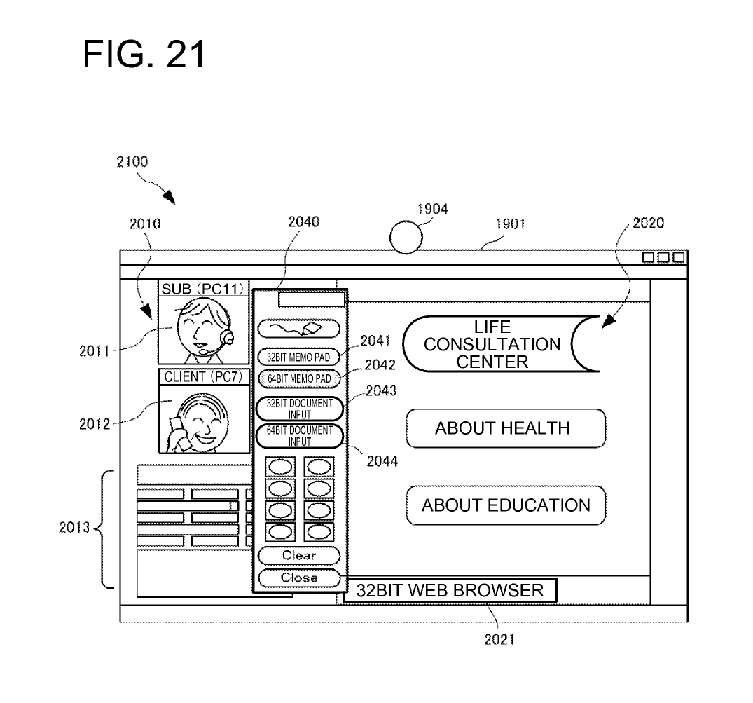

FIG. 21 is a diagram showing an exemplary display screen 2100 when an application is activated in the operator terminal 1810 according to the present embodiment. FIG. 21 shows a screen which is displayed when activation of an application in the operation menu 2013 is instructed.

In FIG. 21, the reference numerals which are the same as those of FIG. 20 denote the same items. In FIG. 21, a drawing tool bar 2040 is open. In the drawing tool bar 2040, a button 2041 for activating a 32-bit OS memo pad application and a button 2042 for activating a 64-bit OS memo pad application are prepared. Further, in the drawing tool bar 2040, a button 2043 for activating a 32-bit OS document input application and a button 2044 for activating a 64-bit OS document input application are prepared. It should be noted that a selection by the buttons 2041 to 2044 is shown for the purpose of explanation. Memo pad applications and Document input applications may be activated on the respective OSs without any buttons. The operator or a client authorized to operate is able to change an image such as drawing in the area 2020 on the shared screen.

In this case, the input instruction information acquisition section 560 in FIG. 5A acquires input instruction information corresponding to the operation, and transmits input instruction information acquired by the information transmission/reception section 530 with the operation processing section of another device, to the operation processing section of the other device, to thereby be in a state where the input instruction information can be displayed on the display of the other device. On the other hand, when the information transmission/reception section 530 with the operation processing section of another device receives input instruction information from the other device, the input instruction information reflection section 570 is in a state where it is able to display the received input instruction information on the display.

### (Sharing of Screen Operation by Activation Application)

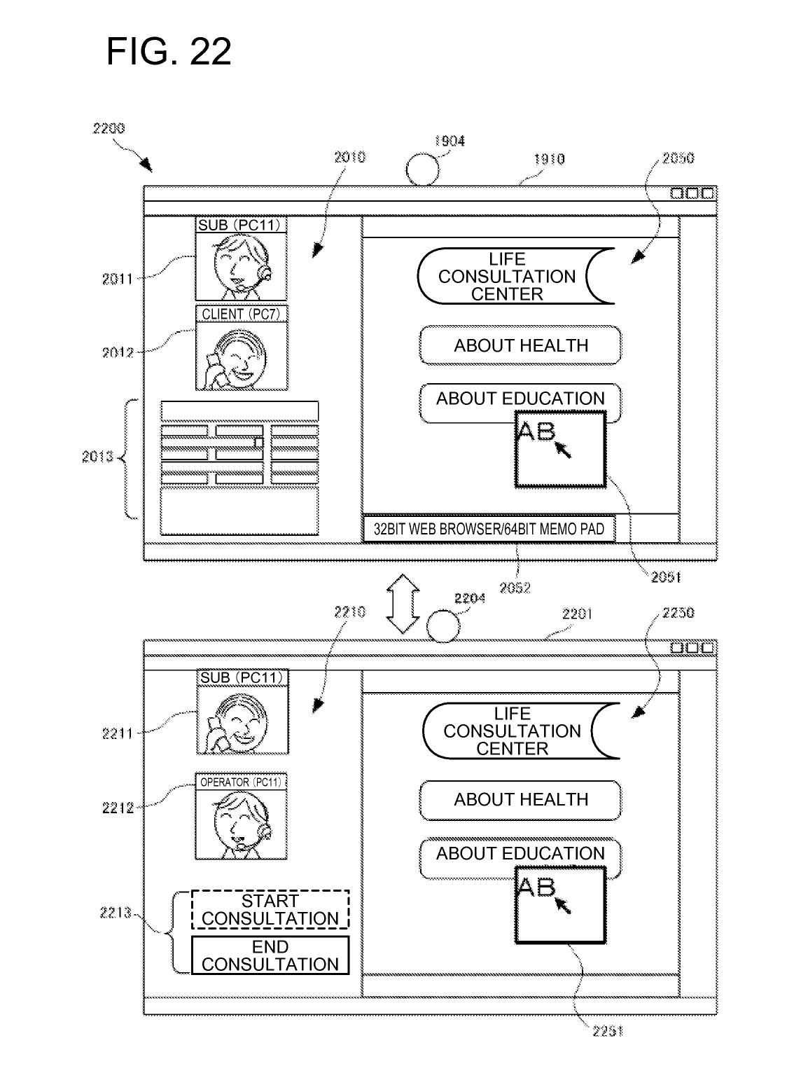

FIG. 22 is a diagram showing an example of sharing a screen by an activated application when the application is activated in the operator terminal 1810 and the client terminal 1830 according to the present embodiment. FIG. 22 shows the case where the button 2042 for activating the 64-bit OS memo pad application in FIG. 21 is selected. It should be noted that the reference numerals which are the same as those in FIGS. 20 and 21 denote the same items.

In FIG. 22, the upper drawing shows a display screen of the operator terminal 1810. In the upper drawing, a cursor area 2051 is shown in a shared content area 2050. In the cursor area 2051, “A” and “B” are input. 2052 shows that the 32-bit OS web browser operates in the operator terminal 1810 and the 64-bit OS memo pad application is executed.

On the other hand, the lower drawing shows a display screen of a display section 2201 of the client terminal 1830. In the lower drawing, a camera 2204 is provided on top of the display section 2201. The display screen is divided into two right and left areas. The left-side area 2210 in the lower drawing is an area for displaying the videos captured by the cameras and an operation menu 2213 of the client. The video by the camera displayed on the upper part is a video 2211 of the client, and the video displayed on the lower part is a video 2212 of the operator. The lower drawing also displays a cursor area 2251 in a shared content area 2250. As the client terminal 1830 is a 32-bit computer, a 32-bit OS web browser is operated, and a 32-bit OS memo pad application is executed. In the cursor area 2251 by the 32-bit OS memo pad application, “A” and “B” are also displayed as in the cursor area 2051 in the upper drawing, whereby the client is able to share the information with the operator.

Here, the cursor area 2051 of the operator terminal 1810 and the cursor area 2251 of the client terminal always move by being displayed at the same position. Regarding operation of the cursor areas 2051 and 2251, the operator preferentially has the right to operate in general, but is able to grant the right to the client.

### (Drawing on the Screen)

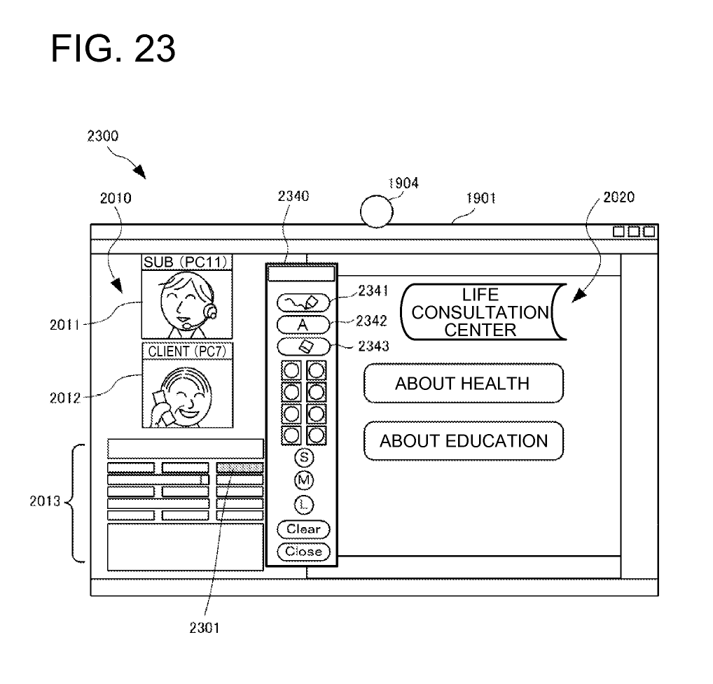

FIG. 23 is a diagram showing an exemplary display screen 2100, at the time of drawing, of the operator terminal 1810 according to the present embodiment. FIG. 23 shows a screen when draw 2301 of the operation menu 2013 is instructed.

In FIG. 23, the reference numerals which are the same as those in FIGS. 20 and 21 denote the same items. In FIG. 23, a drawing tool bar 2340 is open. The drawing tool bar 2340 is provided with a free drawing button 2341 for free drawing on an area 2020 of a shared screen, a character input button 2342 for inputting characters, and a eraser button 2343 for erasing the drawing. The operator or a client authorized to operate are able to draw on the area 2020 of the shared screen.

In this case, the drawing information acquisition section 580 in FIG. 5A acquires drawing information corresponding to the operation, and transmits input instruction information acquired by the information transmission/reception section 530 with the operation processing section of another device to the operation processing section of the other device, to thereby be in a state where the input instruction information can be displayed on the display of the other device. On the other hand, when the information transmission/reception section 530 with the operation processing section of another device receives drawing information from the other device, the drawing information display section 590 is in a state where it is able to display the received drawing information on the display.

### (Sharing of Drawing)

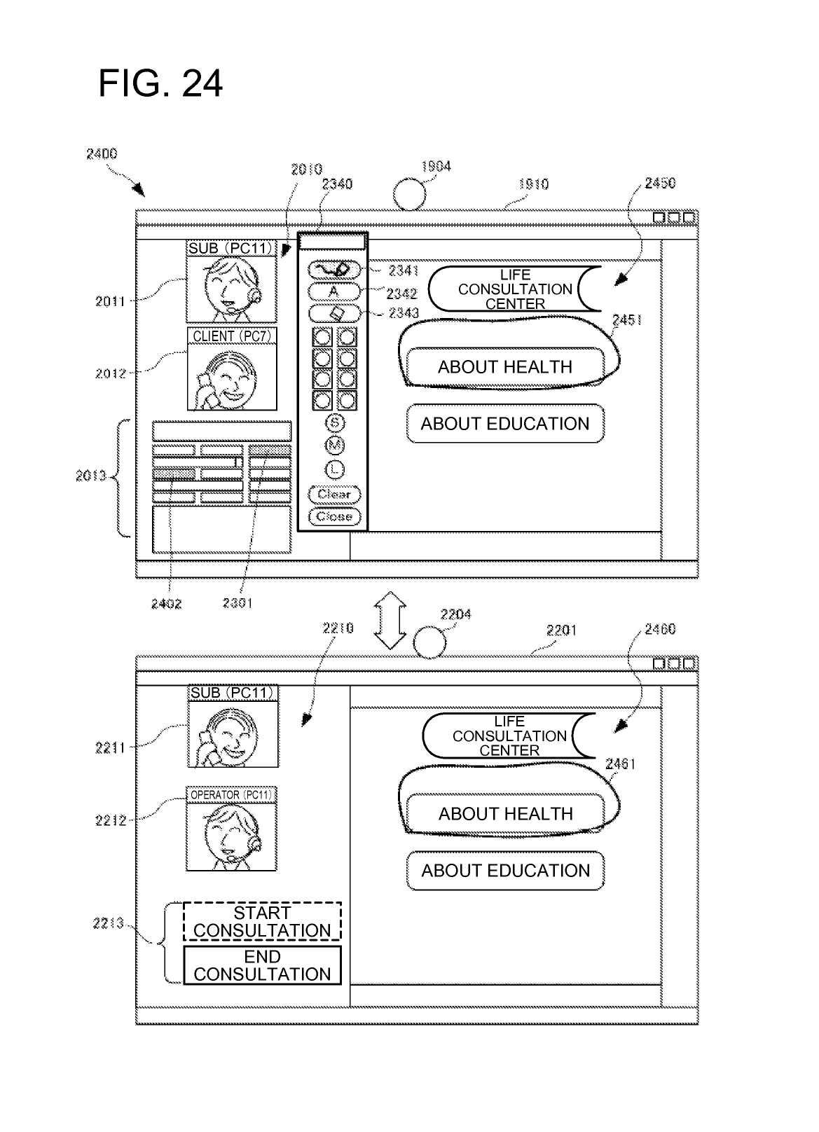

FIG. 24 is a diagram showing an example of scree sharing at the time of drawing between the operator terminal 1810 and the client terminal 1830 according to the present embodiment. FIG. 24 shows the case where the free drawing button 2341 in FIG. 23 is selected and grant of operation right 2402 for granting the operation right to the client is instructed. It should be noted that the reference numerals which are the same as those in FIGS. 20, 21, and 23 denote the same items.

In FIG. 24, the upper drawing shows a display screen of the operator terminal 1810. In the upper drawing, a shared content area 2450 shows an instruction mark 2451 indicating that the client selects “about health” for a consultation content.

On the other hand, the lower drawing shows a display screen of the display section 2201 of the client terminal 1830. In the lower drawing, the camera 2204 is provided on top of the display 2201. The display screen is divided into two right and left areas. In the lower drawing, the left-side area 2210 is an area for displaying the videos captured by the cameras, and an operation menu 2213 for the client. The display of the videos captured by the cameras is configured such that the upper part shows the video 2211 of the client and the lower part shows the video 2212 of the operator. In the lower drawing, the shared content area 2460 shows an instruction mark 2461 indicating that the client selects “about health” as a consultation content. In this way, the client and the operator are able to share the drawing information.

Here, the instruction mark 2451 of the operator terminal 1810 and the instruction mark 2461 of the client terminal always move by being displayed at the same position. Regarding operation of such drawing, the operator preferentially has the right to operate in general, but the right is granted to the client in FIG. 24.

In the present embodiment, processing such as image development corresponding to the operation in such drawing processing is executed by the operation control module 1230. As such, an input of drawing by the operator or the client is developed by the operation control module 1230, and is displayed on the display section of the device to which the drawing is input. At the same time, the input drawing is displayed on the displays of the operator and the client and is shared by them via the drawing information acquisition section and the drawing information display section.

### <Operational Effect of Remote Consultation System>

With the characteristic configurations of the present embodiment, the several types of processing of the remote consultation system 1800 described above can be operated by the user without being aware whether the terminal is compatible with a 32-bit OS or a 64-bit OS.

(Sharing of Screen when Activating Application)

For example, in FIG. 19, the operator first activates the 32-bit OS web browser 1223. In the processing, the operator calls the 32-bit OS operation control module 1230.

First, it is assumed that the operator activates the 32-bit OS memo pad application 1222 by the operator terminal 1810 so as to write a memo in the cursor area 2051 shown in FIG. 22. According to the present embodiment, the 32-bit OS operation control module 1230 selects and activates the 32-bit OS operation processing module 1221.

On the other hand, in the client terminal 1830, when the 32-bit OS web browser 1923 is activated, the 32-bit OS operation processing module 1921 is activated, because there is only one operation processing module. At this point, as shown in the lower drawing of FIG. 22, the shared content and the cursor area 2251 are also displayed on the client terminal 1830, whereby the display screen is shared.

Here, it is assumed that the operator changes the 32-bit OS memo pad application 1222 to the 64-bit OS memo pad application 1212. As in the sequence of FIG. 8, the 32-bit OS operation control module 1230 terminates the 32-bit OS operation processing module 1221, and activates the 64-bit OS operation processing module 1211. Then, even when the operator continues writing to the memo pad (writing into the cursor area 2051 in this example), the display screen of the operator terminal 1810 and the display screen of the client terminal 1830 are continued smoothly between the 64-bit OS operation processing module 1211 and the 32-bit OS operation processing module 1921. In this period, seamless migration is achieved and neither the operator nor the client are aware of a change of the OS environment. Meanwhile, in the case of a change from the 64-bit OS document creation application to the 32-bit OS document creation application by the operator, seamless migration can also be achieved.

(Sharing of Screen when Drawing)

For example, in FIG. 19, the operator first activates the 64-bit OS web browser. In the processing, it is assumed that the operator calls the 64-bit OS operation control module.

Here, it is assumed that the operator selects draw 2301 in the operator terminal 1810, selects the free drawing button 2341 on the tool bar 2340 for drawing, and gives the operation right to the client by instructing grant of the operation right 2402.

On the other hand, in the client terminal 1830, when the 32-bit OS web browser 1923 is activated, the 32-bit OS operation processing module 1921 is activated, because there is only one operation processing module. At this point, as shown in the lower drawing of FIG. 14, the instruction mark 2461 is input and displayed in the shared content 2460 on the display section of the client terminal 1830.

The instruction mark 2461 is directly displayed as the instruction mark 2451 in the shared content 2450 on the display section 19012 of the operator terminal 1810. In this way, the drawing can be shared by the operator and the client.

### Other Exemplary Embodiments

While, in the above-described embodiments, an example in which an operation processing section (operation processing module) is activated in the second application (information operation application) has been described, a configuration in which the second application and the operation processing section are provided independently and the second application calls the operation processing section may be acceptable.

Further, function sharing between the operation control section (operation control module) in FIG. 3 and the operation processing section (operation processing module) in FIG. 5A is not limited to that described in the above-described embodiments. The information transmission/reception section with the operation processing section of another device, shown in FIG. 5A, may be provided in the operation control section, and the operation processing section may perform communications with the operation processing section of the other device via the operation control section, the information transmission/reception section, and the operation control section. Part of the processing (e.g., image development) by the acquisition section, the display section, and the like denoted by the reference numerals 540 to 590 shown in FIG. 5A may be performed by the operation control section. As described above relating to FIGS. 23 and 24, control regarding drawing is performed by the operation processing section. Part of the processing performed by the control section 510 in FIG. 5A may be performed by the control section 310 in FIG. 3.

Further, the operation control section (operation control module) is unnecessary if a computer operates on one platform, as shown in the client terminal 1830 in FIG. 18. Further, if the operation processing section (operation processing module) is able to perform processing of the operation control section by distributing it or if the first application is able to directly activate the operation processing section, the operation control section is unnecessary.

In the above-described embodiments, description has been given in which a 64-bit OS and a 32-bit OS are exemplary used as the first platform and the second platform, a memo pad application and a document creation application are exemplary used as a first application, and a web browser is exemplary used as a second application. However, the present invention can achieve the same advantageous effect in other combinations.

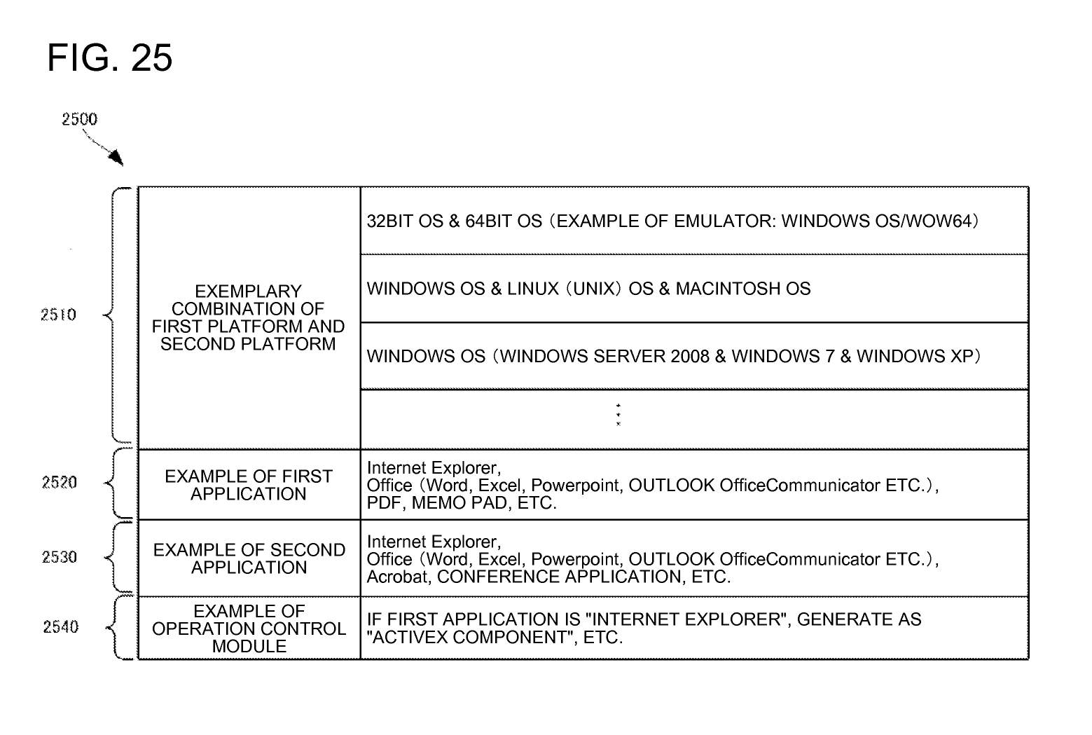

FIG. 25 is a diagram showing examples of platforms, applications, and an operation control module. A reference numeral 2510 denotes an example of a combination of platforms, a reference numeral 2520 denotes an example of a first application, a reference numeral 2530 denotes an example of a second application, and a reference numeral 2540 denotes an example of an operation control module. As is clearly understandable from FIG. 23, both the first application and the second application are applications relating to user interfaces. Further, the operation control module is a program installed in the second application and a program read from the second application. It should be noted that the present invention is not limited to these configurations, and is applicable in a state where various types of platforms operate on one computer.

While the present invention has been described with reference to the exemplary embodiments described above, the present invention is not limited to the above-described embodiments. The form and details of the present invention can be changed within the scope of the present invention in various manners that can be understood by those skilled in the art. Further, systems or devices configured by combining various features included in the respective embodiments are also included in the scope of the present invention.

Further, the present invention may be applicable to a system configured of a plurality of devices, or applicable to a single device. Further, the present invention is also applicable in the case where a control program for implementing the functions of the embodiments is supplied to a system or a device directly or remotely. Accordingly, in order to implement the functions of the present invention by a computer, a control program installed in the computer, or a medium storing such a control program, or a WWW (World Wide Web) server for downloading such a control program, are also included in the scope of the present invention.

It should be noted that in the exemplary embodiments described above, the program is stored in a storage device or on a computer-readable storing medium. A storage medium is, for example, a portable medium such as a flexible disk, an optical disk, a magneto-optical disk, a semiconductor memory, or the like.

While the present invention has been described with reference to the exemplary embodiments described above, the present invention is not limited to the above-described embodiments. The form and details of the present invention can be changed within the scope of the present invention in various manners that can be understood by those skilled in the art.

The present invention is based upon and claims the benefit of priority from Japanese patent application No. 2011-208743, filed on Sep. 26, 2011, the disclosure of which is incorporated herein in its entirety by reference.

### DESCRIPTION OF REFERENCE NUMERALS

100 information processing device
110 first platform
111 first operation processing section
112 application for first platform
120 second platform
121 second operation processing section
122 application for second platform
140 operation control section
213 emulator
231 operation processing section selection table
232 information generation application execution table
240 user interface section
310 control section
320 information transmission/reception section
331 information generation application correspondence table
332 operation processing section correspondence table

What is claimed is:

1-20. (canceled)

21. An information processing device in which a plurality of applications are executable on different platforms respectively, the device comprising:
a first operation processing unit that processes, on a first platform, an operation instruction with respect to an application for the first platform operable on the first platform;
a second operation processing unit that processes, on a second platform different from the first platform, an operation instruction with respect to an application for the second platform operable on the second platform; and
an operation control unit, operable on a given platform, that activates the first operation processing unit or the second operation processing unit and establishes communications, based on whether an activated application is for the first platform or the second platform, the first operation processing unit or the second operation processing unit processing an operation instruction with respect to the application on a platform on which the activated application is operable.

22. The information processing device, according to claim 21, wherein
the operation control unit includes a storing unit that stores platforms on which the applications are executable, and the operation processing units that process the operation instructions with respect to the applications, in association with the application for the first platform and the application for the second platform, and
with reference to the storing unit, the operation control unit activates the operation processing unit that processes the operation instruction on the platform on which the activated application is operable.

23. The information processing device, according to claim 22, wherein
the operation control unit inquires of the different platforms for applications which are operable under control of the platforms, and based on response results, stores the platforms on which the applications are executable in the storing unit, in association with the applications.

24. The information processing device, according to claim 21, further comprising
an emulation unit that emulates, on the different platforms, as if a program operating on one of the platforms operated on another platform.

25. The information processing device, according to claim 21, wherein
the operation control unit operates on either the first platform or the second platform.

26. The information processing device, according to claim 21, further comprising
a plurality of the operation control units, wherein
each of the operation control units operates on each of the different platforms.

27. The information processing device, according to claim 21, wherein
communications between the operation control unit and the operation processing unit are performed by inter-process communications including socket communications which do not depend on a platform change.

28. The information processing device, according to claim 21, wherein
the operation processing unit includes an information transmission and reception unit that transmits information and the operation instruction, input via a user interface, to an operation processing unit of another information processing device, and reflects information and the operation instruction, received from the operation processing unit of the other information processing device, on the user interface.

29. The information processing device, according to claim 28, wherein
by transmission and reception between the operation processing unit of the information processing device and the operation processing unit of the other information processing device which are operable on different platforms respectively, the information and the operation instruction, input via the user interface of the information processing device, and the information and the operation instruction, input via a user interface of the other information processing device, are shared.

30. The information processing device, according to claim 21, wherein
the application is an information generation application for generating information based on the operation instruction via a user interface.

31. The information processing device, according to claim 30, wherein
the operation control unit includes an information operation application for operating the information generated by the information generation application.

32. The information processing device, according to claim 31, wherein
the information generation application includes a memo pad application and a document creation application, and the information operation application includes a web browser.

33. The information processing device, according to claim 21, wherein
the different platforms are different operation systems.

34. The information processing device, according to claim 33, wherein
the different operation systems are operation systems based on different numbers of bits which are 32 bits and 64 bits.

35. A method of controlling an information processing device in which a plurality of applications are executable on different platforms respectively,
the information processing device including:
a first operation processing unit that processes, on a first platform, an operation instruction with respect to an application for the first platform operable on the first platform;
a second operation processing unit that processes, on a second platform different from the first platform, an operation instruction with respect to an application for the second platform operable on the second platform; and
an operation control unit operable on a given platform,
the method comprising, by the operation control unit:
when the application for the first platform is driven, driving the first operation processing unit and establishing communications; and
when the application for the second platform is driven, driving the second operation processing unit and establishing communications.

36. A non-transitory computer-readable medium storing a program comprising instructions for implementing, in an information processing device in which a plurality of applications are executable on different platforms respectively:
a first operation processing unit that processes, on a first platform, an operation instruction with respect to an application for the first platform operable on the first platform;
a second operation processing unit that processes, on a second platform different from the first platform, an operation instruction with respect to an application for the second platform operable on the second platform; and
an operation control unit, operable on a given platform, that activates the first operation processing unit or the second operation processing unit and establishes communications, based on whether an activated application is for the first platform or the second platform, the first operation processing unit or the second operation processing unit processing an operation instruction with respect to the application on a platform on which the activated application is operable.

37. An information processing system in which a plurality of information processing devices, operable on different platforms, are connected over a network, the system comprising:
a first information processing device based on a first platform, in which an application is operable on a second platform which is different from the first platform; and
a second information processing device based on the second platform, wherein
the first information processing device includes:
a first operation processing unit that processes, on the first platform, an operation instruction with respect to an application for the first platform operable on the first platform;
a second operation processing unit that processes, on the second platform, an operation instruction with respect to an application for the second platform operable on the second platform; and
an operation control unit, operable on a given platform, that activates the first operation processing unit or the second operation processing unit and establishes communications, based on whether an activated application is for the first platform or the second platform, the first operation processing unit or the second operation processing unit processing an operation instruction with respect to the application on a platform on which the activated application is operable, and
the first operation processing unit and the second operation processing unit include an information transmission and reception unit that transmits and receives information with an operation processing unit of the second information processing device.

38. The information processing system, according to claim 37, wherein
the information processing system is a remote consultation system in which a user consults with an operator over a network,
the first information processing device is an operator terminal which is operated by the operator so as to respond to a consultation by the user over the network, and
the second information processing device is a client terminal which is operated by the user so as to consult with the operator, who operates the first information processing device, over the network.

39. The information processing system, according to claim 37, further comprising
a server device that provides a common content to the first information processing device and the second information processing device.

40. An information processing method of an information processing system in which a plurality of information processing devices, operable on different platforms, are connected over a network,
the information processing system including:
a first information processing device based on a first platform, in which an application is operable even on a second platform which is different from the first platform; and
a second information processing device based on the second platform,
the first information processing device including:
a first operation processing unit that processes, on the first platform, an operation instruction with respect to an application for the first platform, the first operation processing unit including a first information transmission and reception unit that transmits and receives information with a third operation processing unit of the second information processing device;
a second operation processing unit that processes, on the second platform, an operation instruction with respect to an application for the second platform, the second operation processing unit including a second information transmission and reception unit that transmits and receives information with the third operation processing unit of the second information processing device; and
an operation control unit operable on a given platform,
the second information processing device including:
the application for the second platform operable on the second platform; and
the third operation processing unit that processes, on the second platform, the operation instruction with respect to the application for the second platform, the third operation processing unit including a third information transmission and reception unit that transmits and receives information with the first operation processing unit and the second operation processing unit of the first information processing device,
the method comprising:
when the application for the first platform is driven, by the operation control unit, driving the first operation processing unit and establishing communications;
when the application for the second platform is driven, by the operation control unit, driving the second operation processing unit and establishing communications; and
performing transmission and reception of information between the first operation processing unit or the second operation processing unit, driven by the operation control unit, and the third operation processing unit, via the first information transmission and reception unit or the second information transmission and reception unit and the third information transmission and reception unit.
